(19) United States
(12) Patent Application Publication
(10) Pub. No.: US 2015/0078820 A1
(43) Pub. Date: Mar. 19, 2015

(54) Flow Boulevard; continuous flowing traffic on interrupted urban streets

(71) Applicant: Phillip Jon Brown, Beverly Hills, CA (US)

(72) Inventor: Phillip Jon Brown, Beverly Hills, CA (US)

(21) Appl. No.: 14/028,411

(22) Filed: Sep. 16, 2013

(51) Int. Cl. E01C 1/00; E01C 1/02; G08G 1/07

(52) U.S. Cl. CPC E01C 1/002; G08G 1/07; E01C 1/02
USPC 404/1

(57) ABSTRACT

The Flow Boulevard concepts provide a system of transportation improvement for urban and suburban existing development and or new development. The system provides the optimization of vehicular capacity and level of service for at grade interrupted flow facilities without the widening of streets. The system is comprised of single and couplet street configurations that allow corridors and networks to be developed that have vehicles flowing without stopping throughout the corridor or network. Benefit of true bus rapid transit is attained by removing the necessity to stop at signals and with only stopping for boarding and alighting of bus riders. Consolidation of population increases in low density settings by introducing medium density corridors can dramatically reduce vehicular miles traveled in suburban locations to conserve resources and reduce greenhouse gases. The system of improvement is both inexpensive by using existing streets and has little impact on existing development by not widening streets.

### BACKGROUND OF THE INVENTION

The particular area of invention that the Flow Boulevard would be classified in by the USPTO would be 404/1, roadways. A more common reference that is used by the Transportation Research Board (US) in the Highway Capacity Manual would be that the Flow Boulevard is an Interrupted Flow Facility. Interrupted flow facilities are urban arterials with intersections and the like. Interrupted flow facilities are to be differentiated from Uninterrupted Flow Facilities such as freeways, rural highways and roads with very few intersections and little traffic.

The Flow Boulevard would best be described as an interrupted flow facility because it is urban in use and has interrupting intersections of crossing arterials at grade and has heavy traffic. What the Flow Boulevard (FB) endeavors to do is to minimize the retarding effects of traffic flow interruptions which lower the average speed along the FB corridor and the vehicular capacity of the facility as well. The purpose of the roadway facility is to move people and goods along its corridor and the interrupting of the flow of people and goods works against that purpose.

By a Flow Boulevard being designed to greatly reduce interruptions in the flow of vehicles it is also optimizing the flow of vehicles by designing conditions where traffic in the form of flowing packs of vehicles move through the FB corridor without stopping. In fact it is the objective of a FB to have a continuous flow of packs of vehicles in both directions along the entirety of the FB corridor whether in be in a single street or a couplet configuration. This optimizes the flow of vehicles as well as can be achieved in an interrupted flow facility with intersections having cross traffic at grade. These conditions give the highest level of service and the highest capacity that can be achieved at a given speed of travel as measured on a lane by lane basis of comparison; presumably that being stop and go driving and even progressive signalization on a basic couplet.

Urban vehicular congestion has become a common problem in cities where the travel demand of increased development has outgrown the capacity of its infrastructure. What is also common in these situations is that the infrastructure for moving people and goods is terribly inefficient because of the original street pattern design where there are many interruptions of traffic flow resulting in congestion and the loss of capacity and levels of service (LOS) to provide the needed movement of people and goods. It is the purpose of the FB designs to be used to “fix” these congested corridors and if at all possible to reduce if not eliminate congestion in those corridors to restore the desired accessibility needed to better serve the public.

The usual approach to reducing congestion on urban arterials is through increasing the number of lanes by taking parking lanes or by actual widening of the road bed to add more lanes devoted to moving traffic. And another approach less often used because of having impacts and high expense is that of removing the interruptions of intersections for the crossing of traffic by making grade separations of the cross street intersection so the desired direction of flow does not have a signal for which it may have to stop for. These approaches can have economic and functional impacts which preclude their use in most urban developed areas. Another approach is to provide signalization that favors one direction or another to give longer periods of green signal time or through a synchronization of signals in a progressive manner to give one direction of flow a greater timed function of green lights to produce a better flowing of vehicles. Both of these tactics will normally have very detrimental effects on the less favored direction of traffic flow and that can be very objectionable.

What usually happens in a street with two way traffic in periods of heavy peak travel is both directions of traffic suffer from mixed distances of long and short distances between signals where the short distances fill up completely with congested vehicles and blocks traffic behind it from going through an intersection. This severely reduces roadway capacity and the LOS as measured by maintaining the intended average speed of the corridor and can often lead to near traffic failure with 5 mph traffic during congested periods of travel. Synchronizing signals to provide flow in both directions is normally obstructed by the close spacing of intersections in the urban context and where pedestrians need to cross the roadway. Given the time that is required for pedestrians and vehicles to cross the roadway and the amount of time that is added to that for the use of flowing traffic usually means that signals can be no closer than a mile apart to perform synchronization in the two directions and have a fairly high capacity as well. Inevitably there are some intervening closely spaced street intersections or turning movements that thwart the synchronization and the movement of traffic.

A single street with two way traffic is the difficult urban street to obtain desirable capacity and LOS in both directions at the same time. It is the objective of the single street Flow Boulevard to prescribe the required design that can give the optimization of capacity and LOS that a given number of lanes and speed of movement can obtain in that street. The “sister” configuration of a single street FB is a one-way couplet Flow Boulevard. This configuration has two one way traffic streets (a couplet) that are separated by a city block or more that provide the two way traffic in the corridor. In this configuration both right and left turns from the FB do not have opposing traffic and present little interruption in traffic flow. The couplet FB is differentiated from a basic couplet in that the basic couplet does not have the timing of traffic flow that is required to be attached to a single street FB and also does not have the lane traffic signals which make highly efficient packs of flowing vehicles that are timed with signals so there is no need to stop at the timed traffic signals. Where both the basic couplet and the couplet FB can have high capacities and levels of service the fact is a basic couplet is limited in its use in the urban context and by not having the FB features that make the higher efficient flowing traffic. The main reason for the development of the couplet FB is to develop a system where a single street FB can be connected to with a couplet FB and that a system of corridors can be developed to allow flowing traffic without stopping. The point that is being brought out here is that in the patterns of streets in existing areas of urban development there is not always the opportunity for having a couplet in that portion of a corridor and that only a single street to which traffic can practically be connected to and conducted through may be available. Therefore the single street FB can become a very critical element in making an overall corridor work with high capacity and LOS and to continue the flow of traffic without stopping. Furthermore both of these corridors can be connected through an interchange also without stopping to other corridors to form networks. This type of roadway system can solve major corridor capacity deficiencies and congestion problems and be able to provide this utility at low costs and minimal impacts in the urban context.

Flow Boulevards have a specific urban context in which its application can be made. It is generally a relatively high travel demand area created by a medium density urban area having a range of population between 3,000 to 8,000 people per square mile. The low figure is usually a suburban kind of development and the use of the FB is for making a growth corridor. The higher population range is usually an existing medium density developed area where the capacity of the original street has become deficient relative to the travel demand. The FB system is not applicable in a closely spaced grid of arterials as would be found in the typical downtown urban core setting of a large or small city. And it is not of particular benefit where there is low travel demand and few cross streets as in a more rural context.

So it is the objective of the Flow Boulevard system to make a single street FB that can provide flowing vehicles that do not stop in both directions and be able to connect that facility to the couplet FB facility to make a long corridor by which it can be applied to various urban street patterns by the use of both single and couplet street configurations to provide continuous flow of vehicles along that mixed FB corridor. It is further the objective to use the elements of design and engineering contained in the Flow Boulevard system to be able to connect FB corridors through a FB interchange with another FB corridor. The results of these objectives is to have a transportation improvement system for urban interrupted streets that can greatly reduce congestion and increase mobility in the urban context by the application of the Flow Boulevard system to provide optimization of capacity and level of service for medium density urban development and for lower density suburban development where growth in density is to be accommodated. The further features of the Flow Boulevard system are that of being a low cost transportation improvement with little impact to existing development which has great utility and it can be instrumental in improving social and economic development through improved commerce.

### BRIEF DESCRIPTION OF THE DRAWINGS

FIG. 1: Flow Boulevard Corridor with Crossing Arterials

This single street Flow Boulevard corridor (a) is depicted as a lineal configuration with arrows pointed in two opposing directions depicting right hand drive of vehicles in the two directions. The diagram then shows three arterials (b) crossing the Flow Boulevard with arrows again depicting traffic flow, however there could be one way streets give the street pattern. The main point to make is that these intersections are at grade along with the Flow Boulevard (FB) and make an interruption in the flow of traffic of the FB by doing so. Each intersection of the “a” and “b” streets is called out as an “On Module” intersection. These intersections will have the standard signalization that cover all the various traffic movements found in a normal urban at grade intersection (see FIG. 4 for clarity).

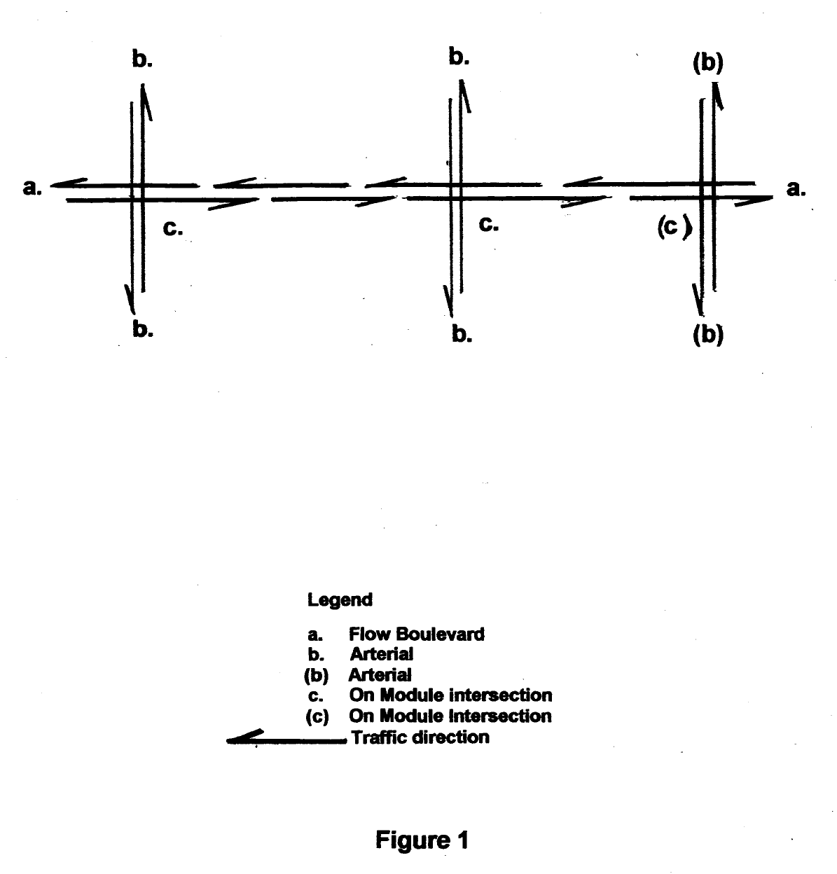

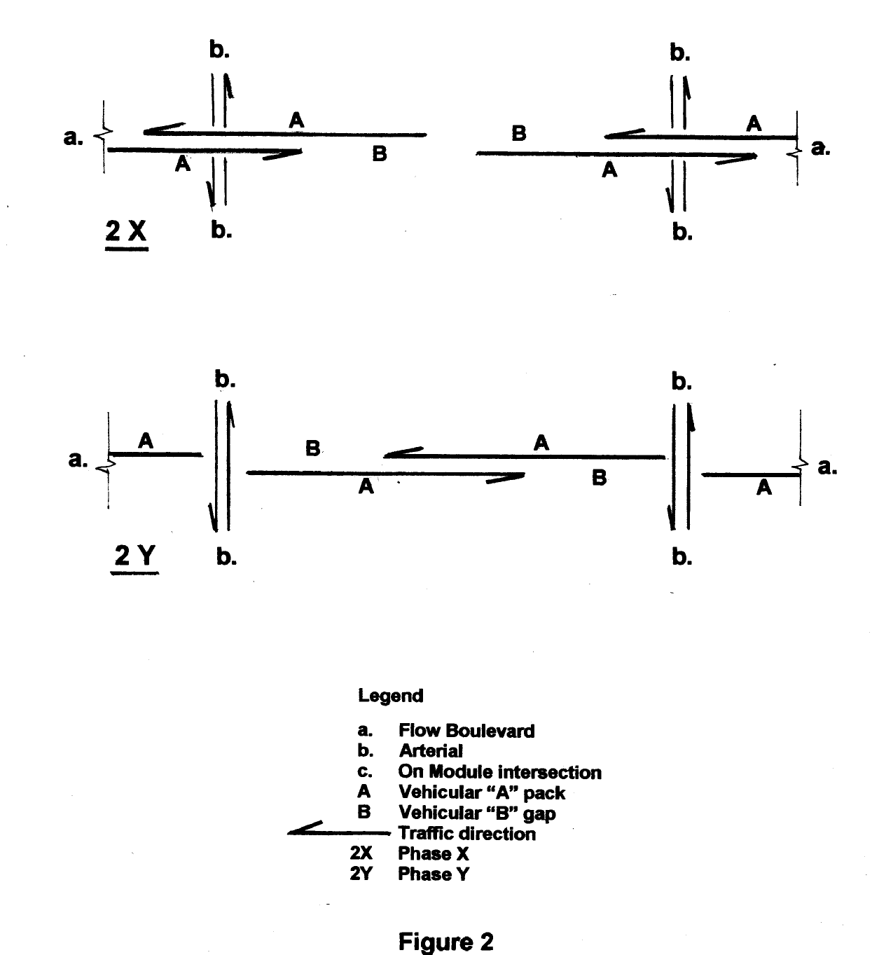

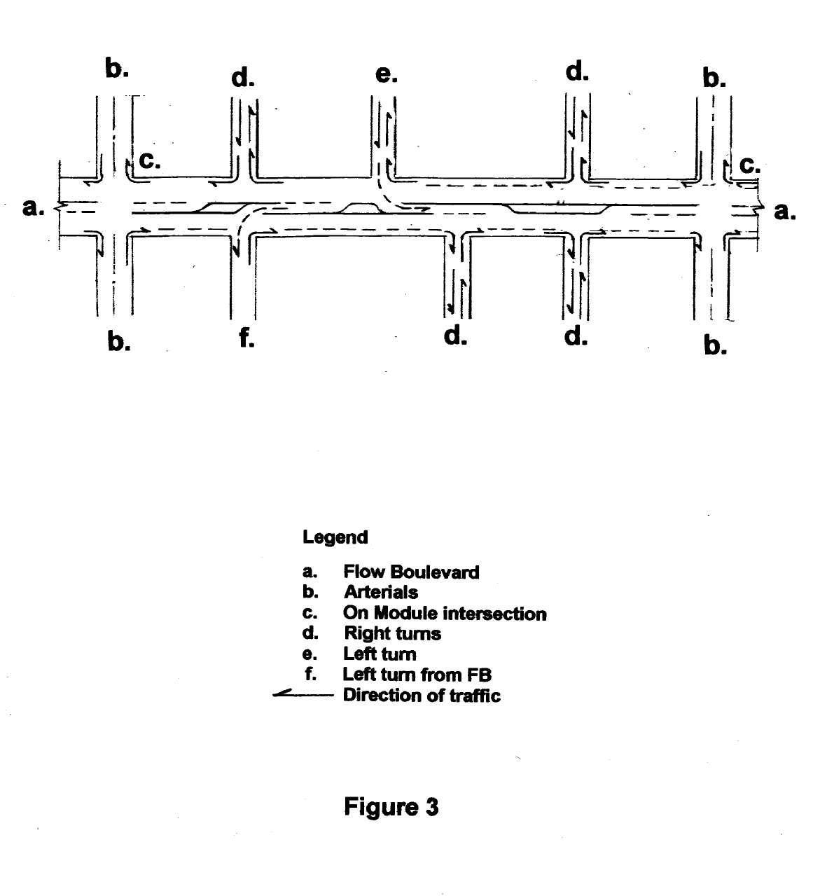

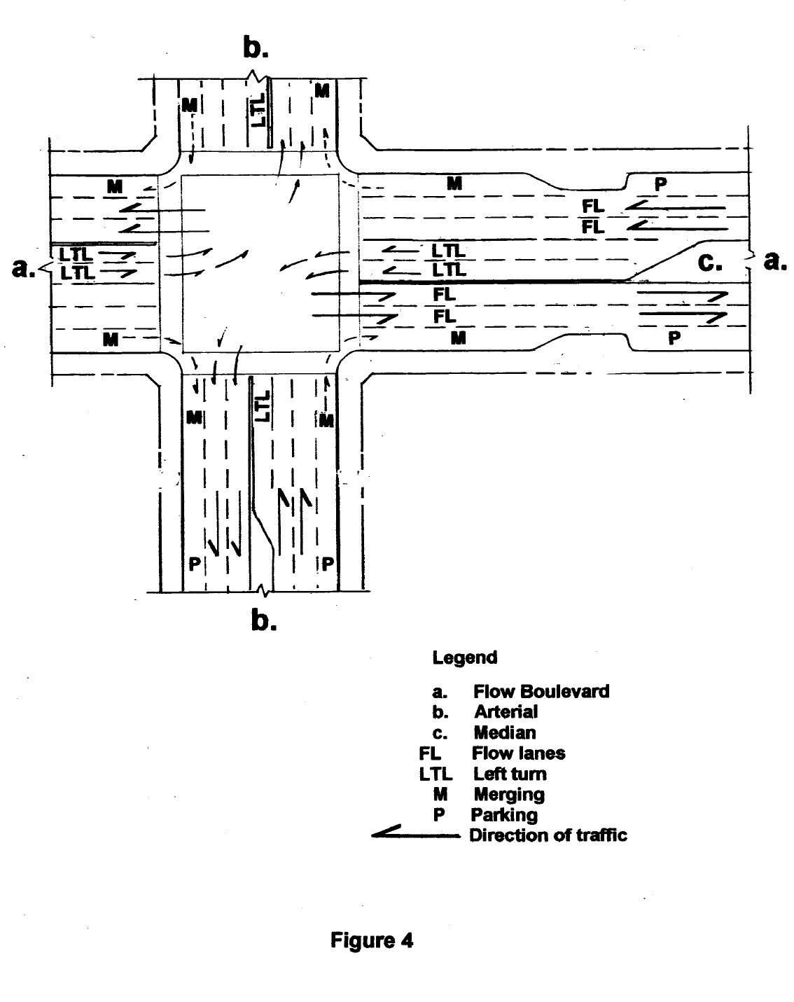

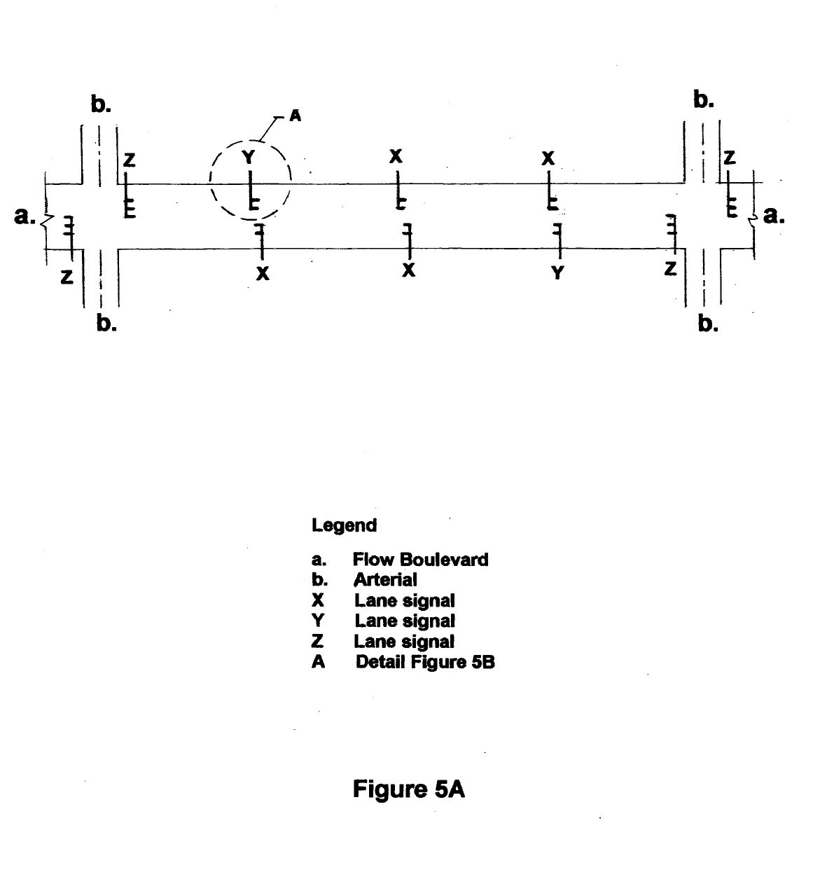

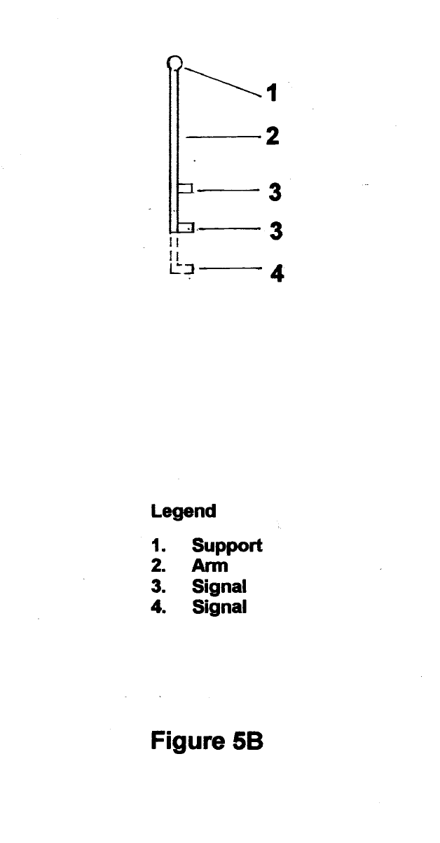

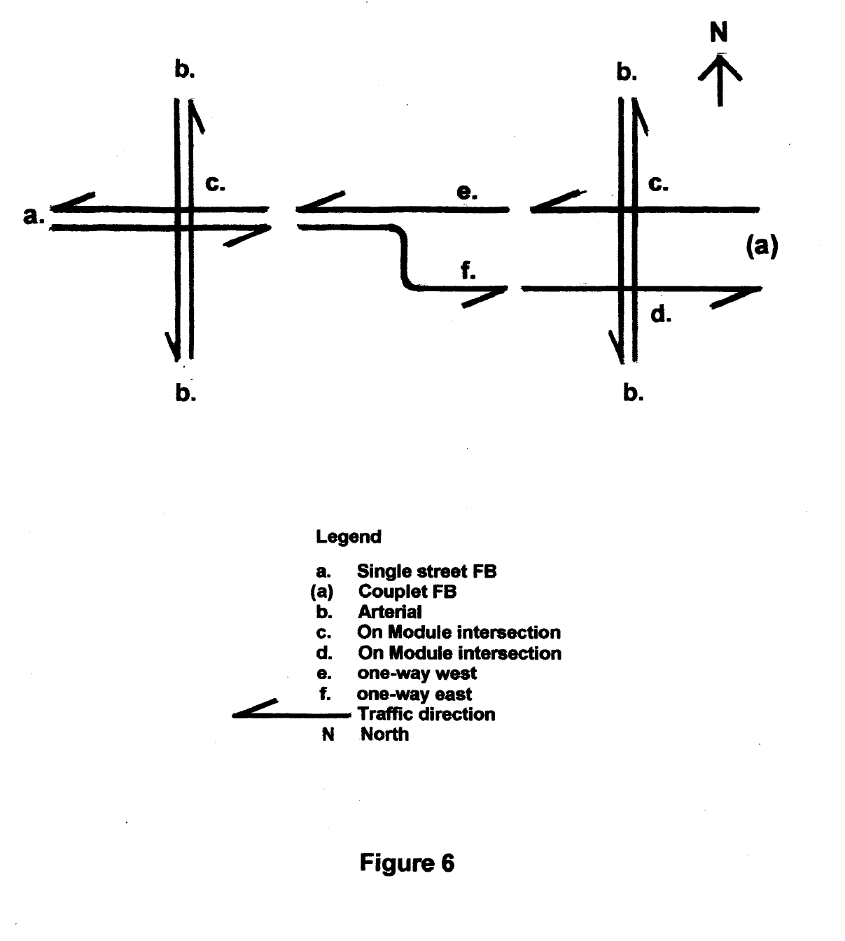

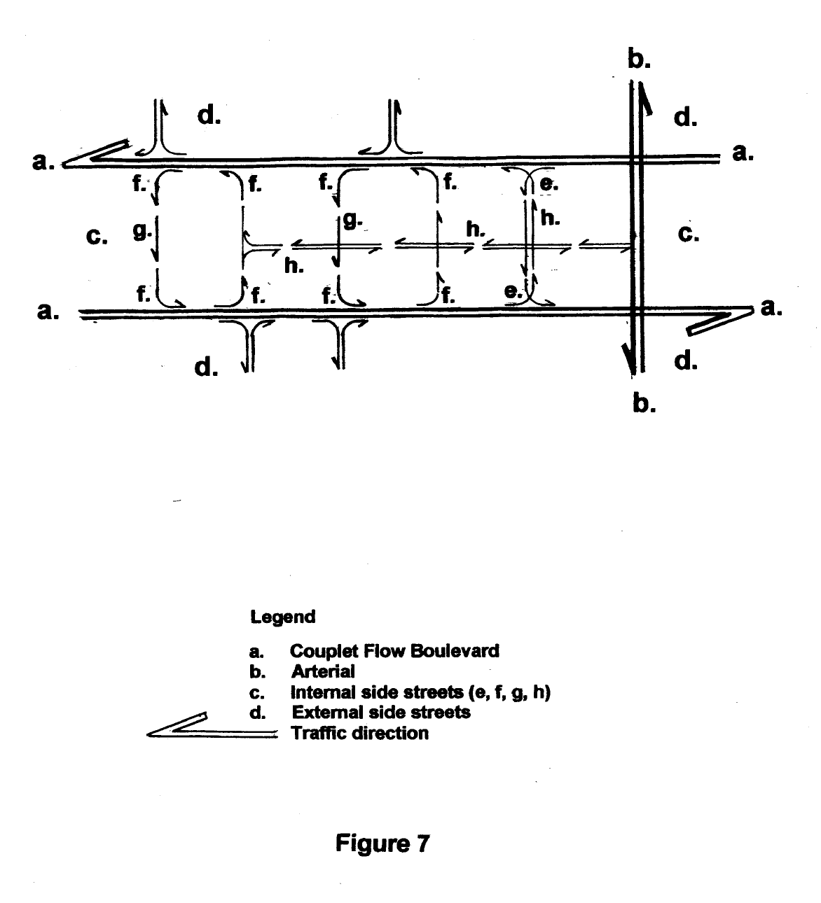

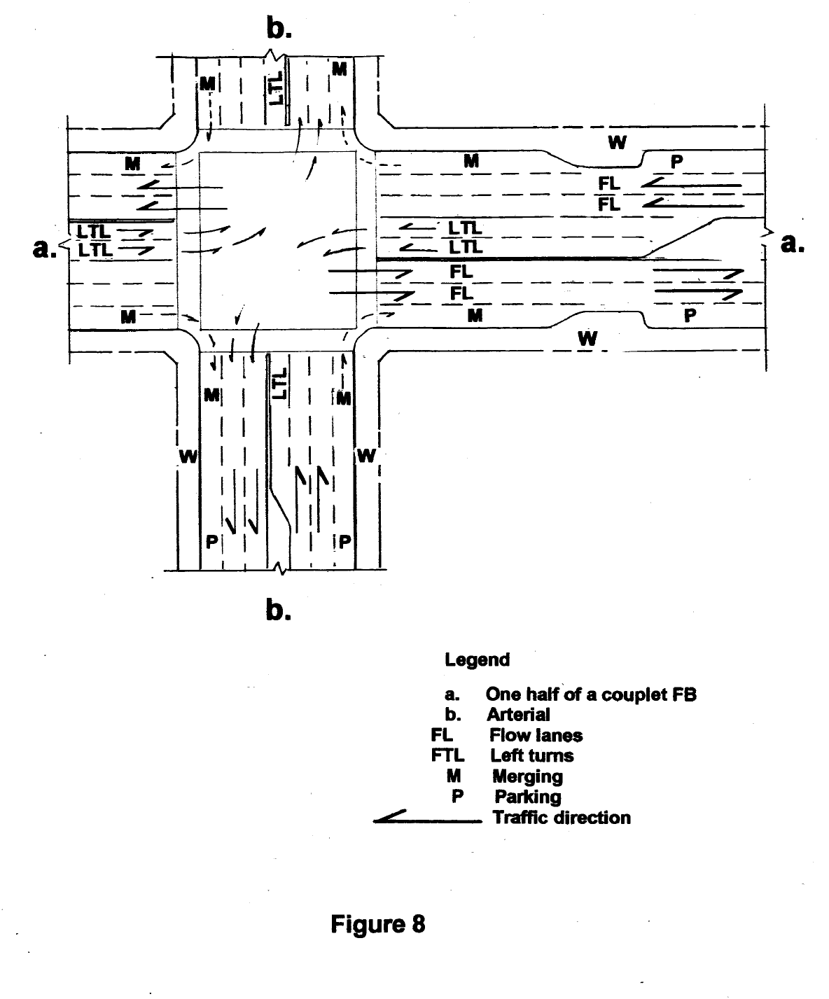

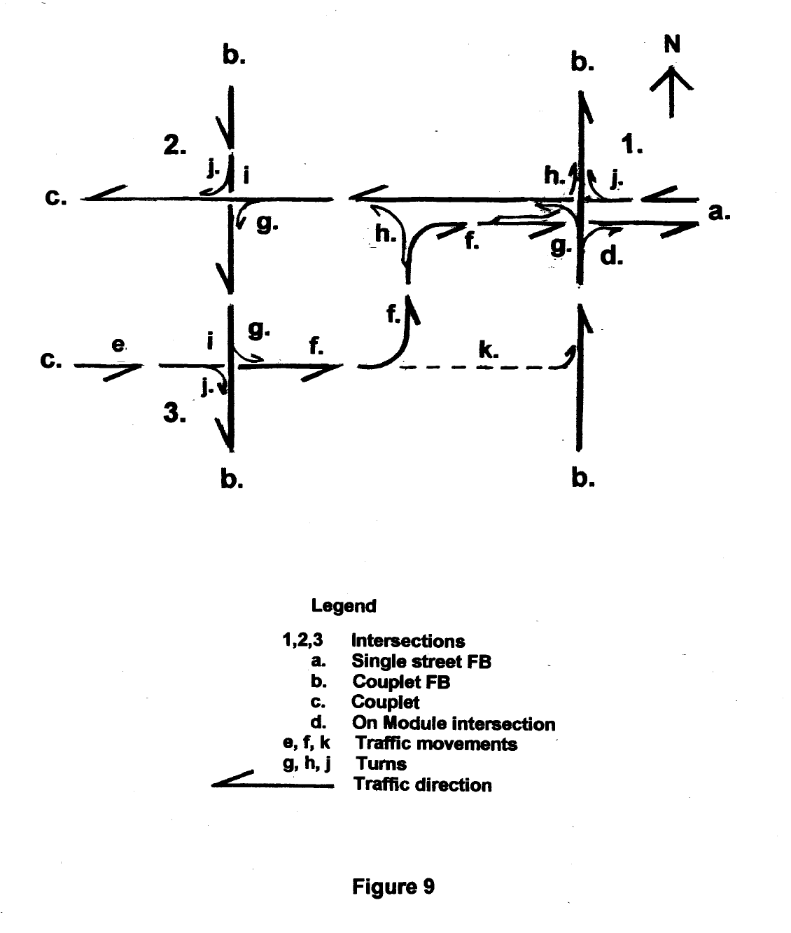

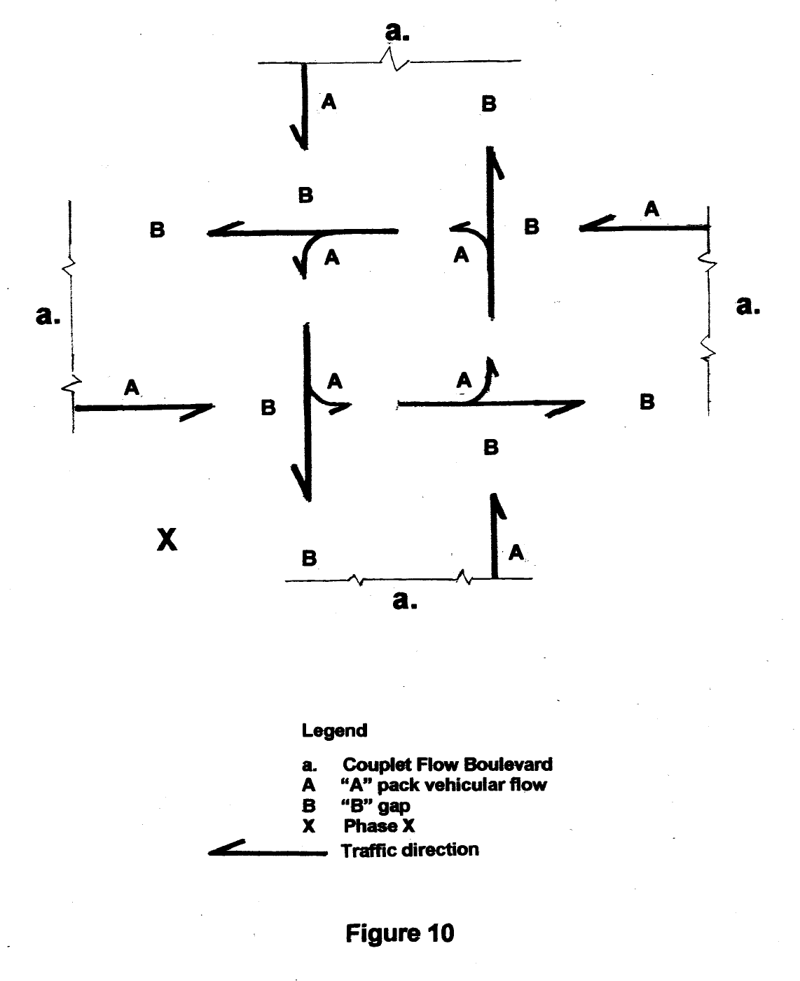

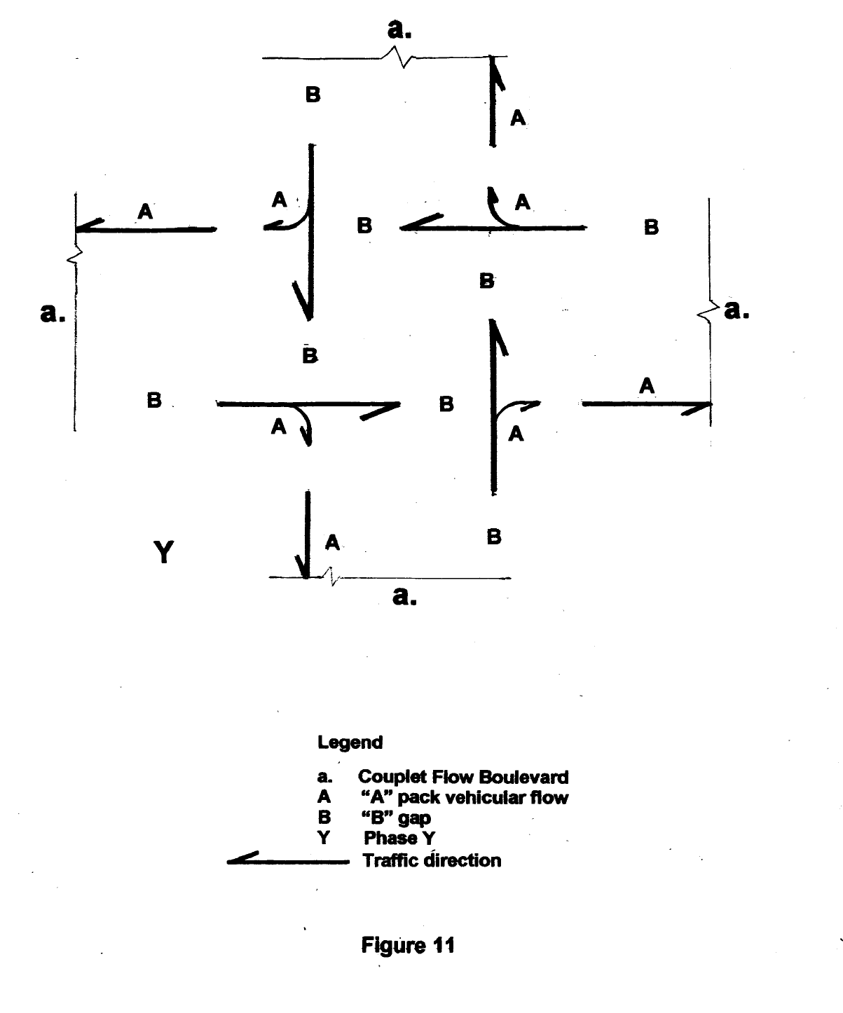

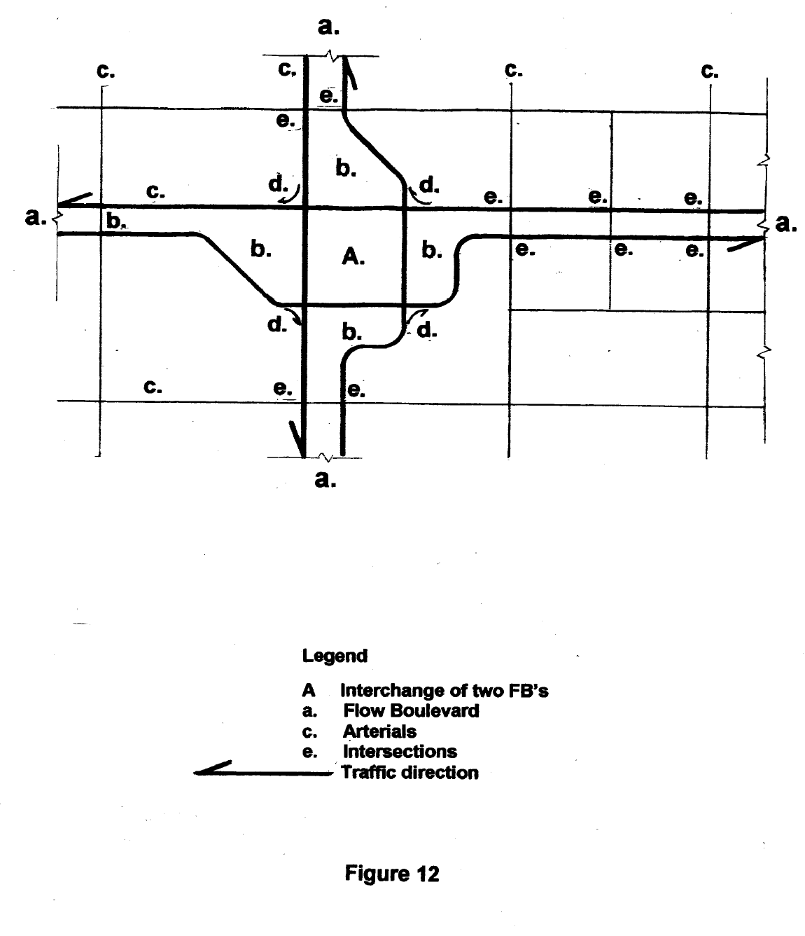

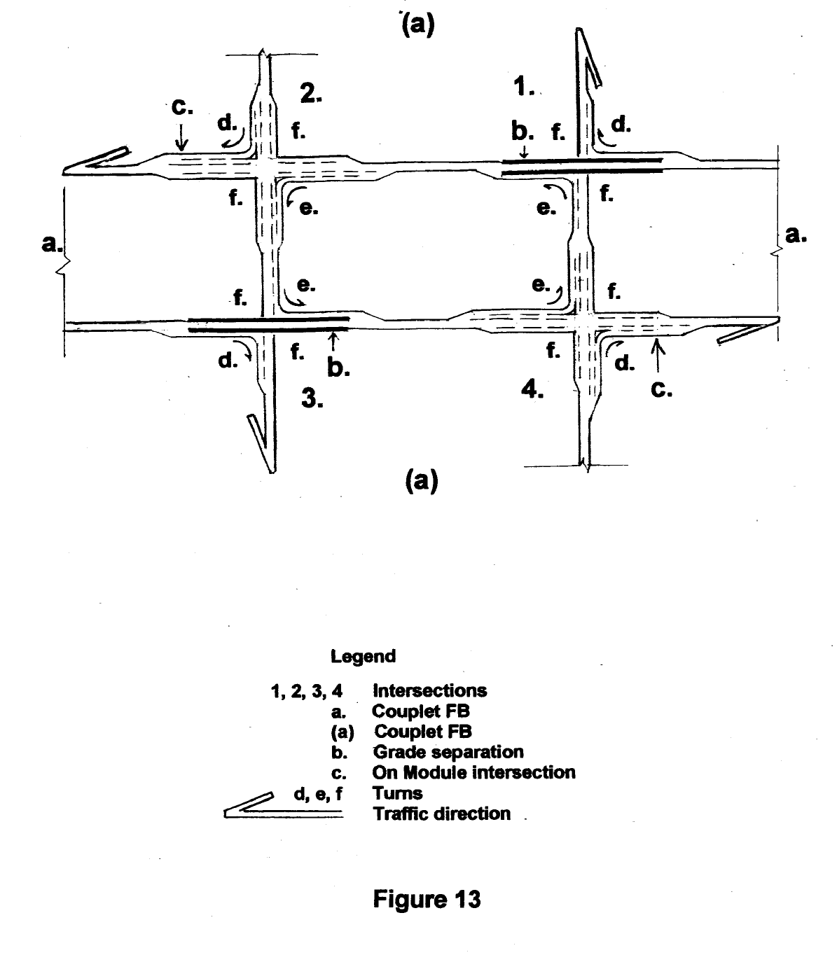

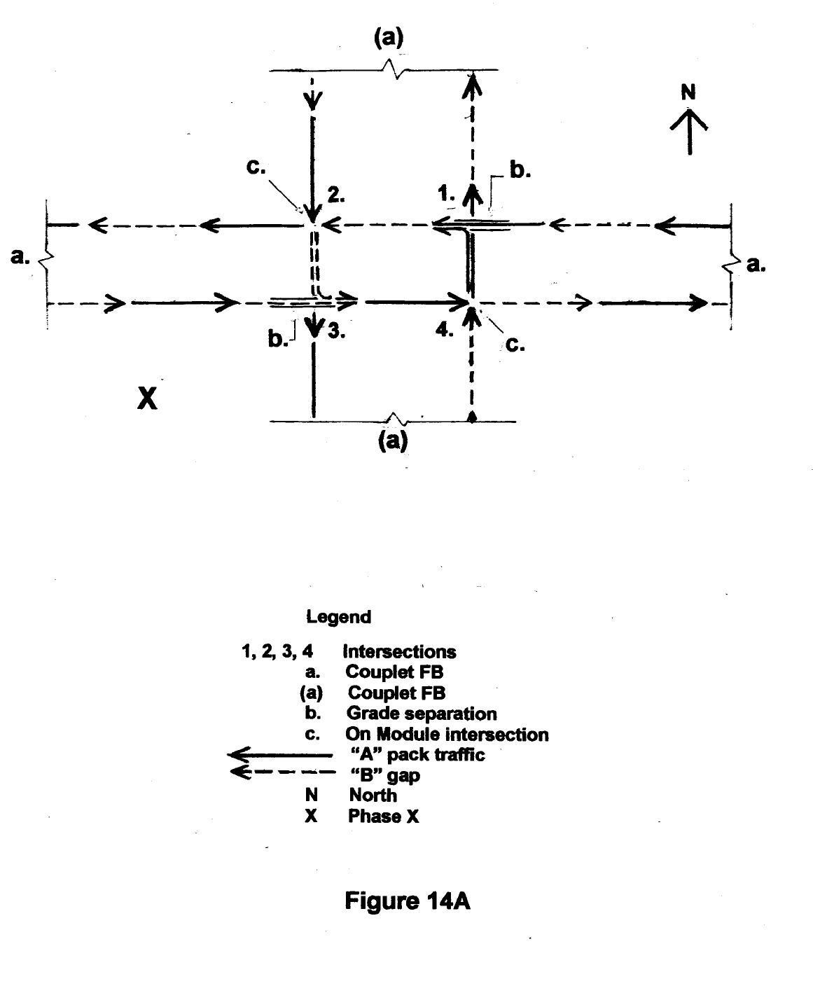

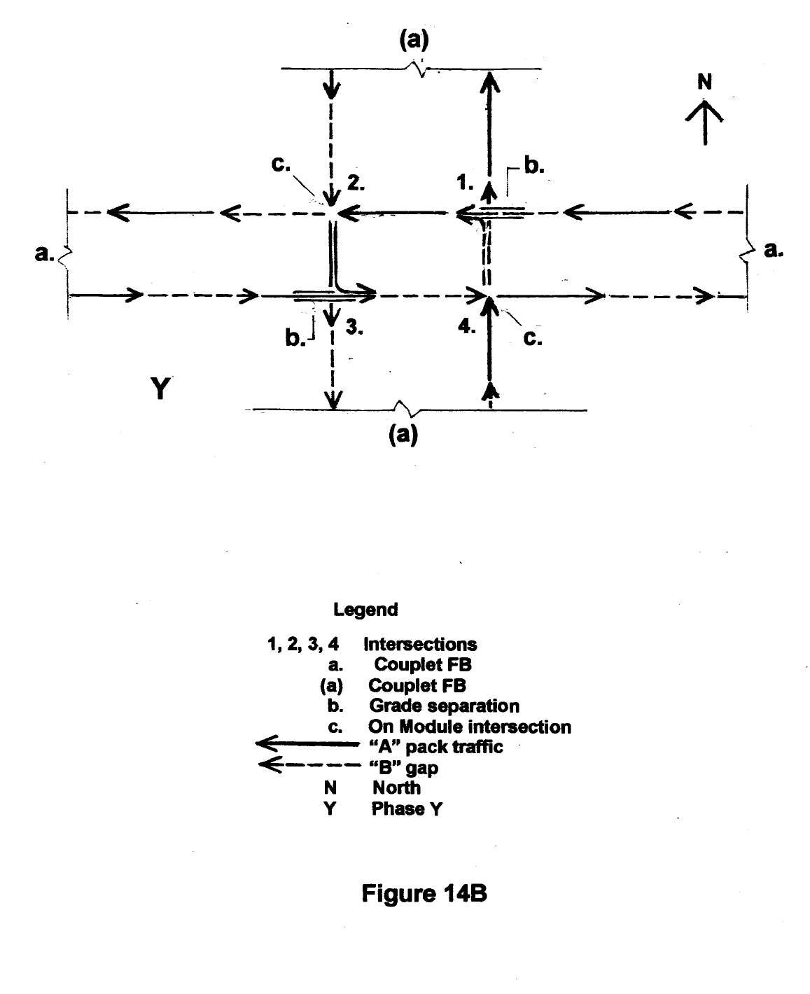

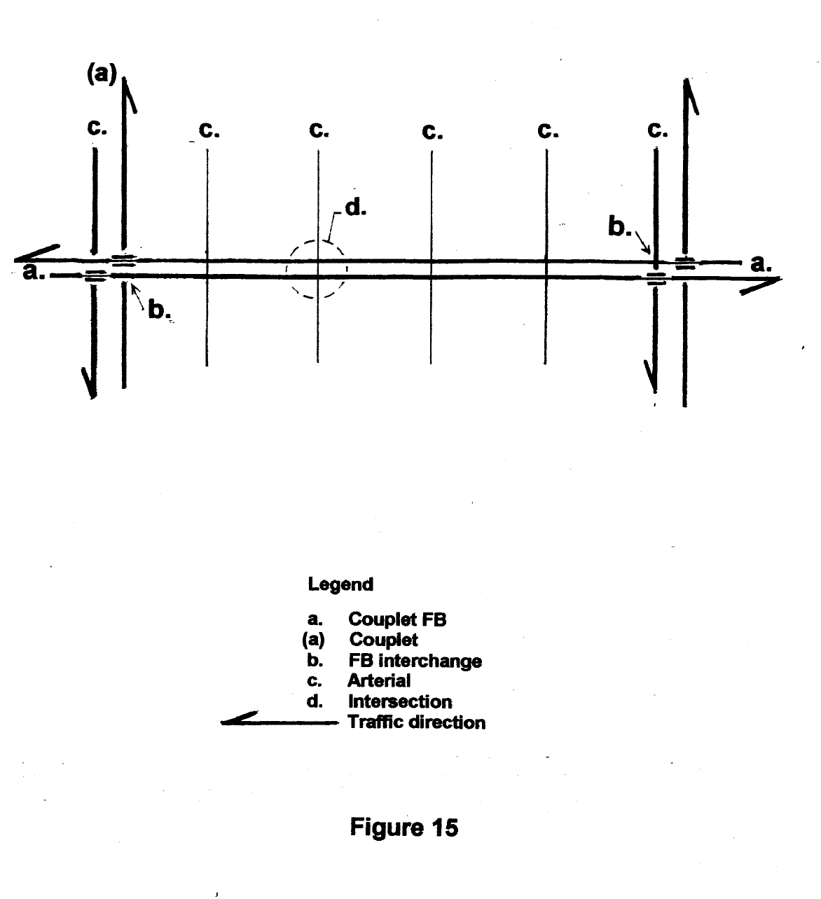

The main idea behind this drawing is that the On Module intersections are spaced and timed to perform with a general speed of travel so that On Module intersection signals have a common signal cycle that will occur at the same time throughout the single street FB. Although segments between On Module intersections may vary somewhat by adjusting the speed of travel in that segment so that vehicles will still arrive at the On Module intersections in the corridor at the same time. Shorter that average segments will have slower speeds and segments with somewhat greater distances between On Module intersections will have higher speeds than the basic distance between intersections established for the corridor. In FIG. 1 the 1 mile spacing is depicted as the standard with 30 mph as the standard speed for the corridor. As an example the shorter 0.8 mile segment is a variation with a shorter separation and to adjust for this a 24 mph speed would be enforced in that segment of traffic flow. Again all the On Module FB signals will be cycling through their basic green and red periods at the same time, in this case a 2 minute cycle that will then repeat simultaneously one after the other throughout those single street Flow Boulevard connected segments. In order to optimize the FB capacity the signal cycle green phase would be longer than its red signal phase; for example 75 seconds to account for the flowing and turning movement phase of the FB and for 45 seconds for the crossing traffic and its turning movements for the arterial crossing the FB.

FIG. 2: Packs and Gaps Flowing Through Intersections

The two diagrams depict two different signal phases of the signal cycle in a segment between On Module intersections of the single street Flow Boulevard. Diagram X shows the green phase of the signal cycle for the flowing “A” packs of vehicles to pass through the On Module intersection by essentially entering and exiting that intersection at the same time from both of the opposing directions without stopping their flow through the corridor. To accomplish this function the “A” packs have been formed by lane signal prompting as described in FIG. 5. In the same manner the “B” gaps between the flowing “A” packs are also formed by lane signal prompting. So in Diagram Y what is depicted is the arterial traffic crossing through those “B” gaps performing its movement of traffic during the red signal phase of the FB signal cycle but not interrupting the flow of the continuously flowing “A” packs while doing so because the “B” gaps are formed to provide for the time it take for the cross arterial traffic to clear.

The “A” packs are given “compaction” prompting given the relative amount of travel demand through the day. Light traffic receives greater spacing between vehicles and heavy traffic during peak travel periods receive closer spacing. The lane traffic signal prompting is a separate signal system from the On Module signals but of course would have the coordination that makes the “A” packs and the “B” gaps perform appropriately at the On Module intersections. The On Module signals are a kind of “fail safe” set of signals that would govern ill-formed packs and gaps.

These two diagrams show the basics of how the continuous flowing of the packs of vehicles is achieved and how the stop and go driving of the intersecting arterials do not interrupt those flowing pack of vehicles.

FIG. 3: Turning Movements Between Intersections

This figure is to show that there is need to provide turning movements between On Module intersections to serve the needs of mobility for the adjacent community. Even though the On Module intersections serve arterials and would account for the majority of cross traffic the intervening traffic movements of b, c and d in the figure can serve many movements that would otherwise burden the On Module intersections. So these intervening traffic movements provide access to and from the FB not only for the residents but for goods delivery and emergency vehicle access.

The “b” traffic movement from a side street making a “T” intersection with the FB allows rights from the FB into the side street and out of the side street onto the FB. As an option given the adjacent land use and the travel demand an adjacent community, possibly single family residential may take the option to not connect to the FB and have the side street cul-de-sac instead. It should be noted that a parallel street to the FB would probably be an important and convenient street to provide collection and distribution of trips to and from the adjacent community to the near by arterial for crossing the FB directly and for other circulation. The “c” left turn traffic movement from a side street entering the FB is again desirable for mobility as is the “D” left turn movement to exit the FB to enter the land use on the opposite side of the FB. These particular turning movements can be expected to be used to connect to some what more heavily traveled streets commonly called local collectors. It is even possible to serve arterials with medium levels of travel demand by the median being able to have queues with two lanes of traffic for entering or exiting the FB. And for that matter right turns can be doubled up to serve entering or exiting the FB with “b” side streets as well.

With all that said above for accessing and exiting the FB at grade with the b, c, d, and the crossing and turning movements provided by the On Module intersections also at grade there may the occasion that a “Off” Module intersection would need to be made with the FB. This can only be done with the making of a grade separated intersection that favors the FB with the ability to maintain the continuous flowing of the “A” packs and “B” gaps without interruption in order to preserve the integrity and purpose of the FB. Although the grade separation may be necessary and expensive those costs have to be weighed against the benefit which the FB provides. This kind of intersection is commonly called a diamond intersection and is usually found in use with an uninterrupted flow facility.

In any event grade separations are not a part of the FB concept that makes the FB work. Grade separations are simply special situations that would need to be dealt with as would be a river crossing or that of a set of train tracks might present. All though grade separations are not part of the invention, as a practical matter those special situations are mentioned here and would have to be resolved so that the benefits of the FB are maintained.

FIG. 4: On Module Intersection of Flow Boulevard and Arterial

The On Module intersection looks like the typical on grade intersection that can be found in many an urban location and as a matter of fact is like them. What is different is when the FB flowing packs of vehicles arrive at the intersection and the gaps between them to allow cross traffic and turning movements to occur.

The FB would have one or more flowing lanes (labeled “FL”) in each direction. A median (as labeled) is required to provide a queue lane (or lanes) for left turns (LTL) from the FB onto the arterial. This movement takes a portion of the basic 75 second green signal period (as has been described) devoted to the FB “A” pack movement. Left turns may take 11 seconds from the 75 seconds leaving 64 seconds for the flowing portion of the “A” packs. Right turn merge lanes (M) are most often necessary so there is not interruption of the flowing lane vehicles.

During the 45 second arterial movements, as described as their portion of the overall 2 minute signal cycle, the crossing and turning movements from the arterial respond to the normal signalization that occurs in this type of intersection.

To repeat what is different concerns when the FB flowing traffic arrives at the intersection. It arrives in a timely and well formed manner flowing into the intersection just after the green signal period begins. The flowing packs cease to occur just before the left turns from the FB to the arterial begin. The left turns cease just prior to when the arterial green period begins for the crossing and turning movements are made. Those arterial movements are made during the FB “B” gap period. Then the cycle is repeated over and over allowing the “A” packs to flow through the FB without stopping.

FIG. 5: Diagrammatic Arrangement of Lane Traffic Signals

Lane signals are the follow through or enforcement of the Flow Boulevard concept of formed packs and gaps that allow the best average given speed and the most optimum capacity to be achieved in that urban interrupted flow facility. Lane signals assure that the formation and spacing will be appropriate for both the packs and gaps in providing the conditions for the high LOS and capacity to be attained.

It should be said that there would likely be a learning phase for both the drivers of the FB and for the adjusting of signal prompting in order to get the most out of the FB facility. Since the FB operation basically doubles the capacity of the given number of lanes in the typical corridor that a FB would be applied to, there would be an adequate period of time of a lower potential capacity period that learning could be carried out before heavier travel might be attained through growth and development of the corridor. The lower potential capacity period would have less of a need to “compact” the “A” packs and would more time to assure the formation of gaps between the packs.

Now, to get to the lane traffic signal operations. The lane signals would still use the basic green, yellow and red format of signals but with refinements in signaling in order to better prompt driving behavior. As a prerequisite to the signaling in the FB corridor there would need to be preparatory signaling and timing to begin pack and gap formations before the entering the corridor. By the time packs and gaps are in the FB corridor the range of needed formation prompting for the FB to operate should be now be able to be performed by the lane traffic signals in the FB corridor. With this recognition the lane signals are to compact the “A” pack formations to optimize conditions given the current travel demand; light travel allowing greater spacing between vehicles and heavier travel requiring closer spacing.

The “X” position of the lane traffic signals would have the basic purpose of maintaining the given speed of traffic flow for that segment of FB and the amount of compactness given the current travel demand. Green lights prompt the maintaining of the desired speed, blinking green lights are for speeding up the movement to obtain closer spacing. Yellow lights are for reducing speed forming less need for vehicular closeness and blinking yellow lights are for caution and slowing of travel while yellow blinking lights accompanied with a red light is for signaling preparation of a very slow speed or potential stopping and a lone blinking red light is for stopping.

As shown in the diagram there would likely be 2 or more of the X position lane traffic signals for the purpose of forming appropriately formed vehicular packs and of maintaining the appropriate speed of a flowing pack while also separating a pack with a well formed “B” gap so as to end up with the portion clear of vehicles that will allow the arterial traffic movements to be performed at the On Module intersections so there are no interruptions in the flow of “A” packs through the FB corridor. Sorry for FB like continuous flowing sentence.

The Y position lane traffic signals are a more intense use of forming packs and the following gaps so that there will be no vehicles out of place when the pack enters the On Module intersection. If there is a straggler that vehicle (or those vehicles) will be directed to nearly stop in order to now be formed as a part of the following pack. This is so there will be no stopping of vehicles at the On Module intersection which would create a disruption to the flow of the flowing A pack that will follow. Between the Y and Z lane traffic signal positions the stragglers are required to move very slowly in order to prepare to accelerate when given the blinking green light at the Z position in order to now be at the beginning of the A pack that has caught up behind. This is all to maintain the well formed A packs and B gaps so the FB works with flowing vehicles without interruptions.

The Z position lane traffic signals have an even greater purpose of controlling the packs and gaps of the FB in that this is the last prompting that can be made before the On Module signal. At this Z position there the same basic prompting as found at the Y position but these promptings have become more acute. In addition there are signals that prompt the appropriate use of the left turn queue lanes. Basically if the left turn queue is full it will display red signals indicating that the approaching vehicles will not be allowed to attempt to turn into the left turn queue pocket. The Z position would also have photo or other enforcement for violations of not responding correctly to the signal prompting in any of the flow lanes or lanes for turning.

If a straggler has made inadequate choices it would be smart to simply move to the right to find a merging lane to get off the FB flowing lanes. By the time critical timing and spacing of vehicles are needed to require a FB to be made to provide adequate transportation in a corridor the restrictions for the parking lanes during peak travel periods would likely only to allow for emergency vehicles, maybe some taxis and definitely for long bus pockets with additional deceleration and acceleration room to maneuver in. Off peak hour general parking might take place when there is light traffic and the gaps between packs can be taken advantage of for the needed parking maneuvers.

As a note on the lane traffic signal operations it would be said that the exact program for signal controls can not be prescribed here because there so many behavioral, varying travel demand conditions and specific FB corridor elements to be accounted for. Those programs and electronic controls are of a separate discipline outside that of the FB concept. It is reasonable to assume that sufficient controls can be attained to provide the pack and gap formations so that the single street Flow Boulevard can be made to work. In the Detailed Description of the Invention portion of this Specification there will be further discussion on these relationships and what is expected for the performance of this invention.

FIG. 6: Single Street FB Connected to Couplet FB

This is a very likely connection to take place because there are found both patterns of streets in the urban street layout; single street main corridors and parallel streets in arterial grids from which to make each kind of FB.

On the left side of the image of FIG. 6 is the single street FB (a) and has an On Module intersection (c) prior to the splitting of the two directional traffic flow from being contained in one street right of way into two separate street right of ways with the couplet FB (b) represented by elements (e) and (f). Element (c) represents the On Module intersections. It should be noted that on the directional flow of the couplet FB (element e) prior to going into the single street FB, the On Module (c) intersection on the right side of the image is needed to prompt the packs and gaps so that the single street FB works at its initial On Module intersection (c) on the left side of the image. This is in contrast to the intersection (g) where the directional flow of traffic has come out of the single street FB. These two different intersection requirements are exhibited in the right side if image of FIG. 6 one above the other on the (d) arterial.

In the lower part of the image is shown an “adjusted” average speed because of the greater distance incurred between by the splitting away of street (f) from the single street FB. The adjusted higher speed of 33 mph does not have to be made if the couplet FB does not need to be synchronized with another Flow Boulevard element requiring packs and gaps further east (and off the image to the right). In other words the two streets of a couplet FB do not have to have On Module intersections at related arterial street crossings because the intersections are separated and do not have the different directions of opposing traffic going through the same intersection at the same time that requires pack and gap organization for that to occur. On the other hand if there are other FB elements that need pack and gap organization for them to occur, another segment of single street FB, or an interchange of couplet FB's (see FIGS. 8 and 9) or other such FB elements, then there is not a required synchronization of intersections © and (g) on the (right hand side of the image) arterial (d).

FIG. 7: Couplet FB with Crossing Arterial and Side Street Connections

This Figure represents the couplet FB operations. The couplet one-way pair of streets (a) are separated by a block or more and the internal streets (c) between them may be one way (g) or two way streets (h). The safer connections to the flowing traffic on the FB would be a left turn off the FB and a left turn onto the FB using a one way side street with the FB as represented by connection (f). But with circumstances accounted for a crossing set of left turns where a two way street was connected to the FB, as in the connection (e); that could be made.

As for the side streets that are external in location to the couplet FB as in the (d) areas; a simple right turn off from the FB into the side street and a right turn out of the side street onto the FB makes the typical connection. As in the single street FB major cross FB traffic is made at the arterial crossings of the FB. FIG. 8 shows a typical intersection for what is called out here on FIG. 7 as Intersection (b). So traffic crossing the FB is primarily directed to the arterials with intersections at grade.

One can see however, that travel can be made across the couplet FB from the external side (d) to the internal couplet area (c) by first taking a right turn onto the FB from an external side street, then merging left in the FB lanes to then take a left turn into the (c) internal area. Then continue travel until the other couplet street is reached to then upon make another left and enter the flow of that couplet street. The merge to the right hand lane of that couplet street and make a right onto a side street in the (d) external area. It would be expected that these kinds of crossings of the couplet FB would be few in number and mainly made by those making short distance trips from one side (d) to the other (d); or for that matter from just the internal area (c) to an external area (d) or vise versa. If there was the need to accommodate heavier travel demand then the following characteristic of the couplet FB would have to be taken into account.

A couplet FB unconnected to other FB corridors for example, generally do not need an On Module intersection for arterials that are spaced and timed for two way traffic. By having the two separated intersections as shown in FIG. 7 as (b) intersections, “A” packs and “B” gaps are not passing one another in the intersections simultaneously and therefore do not need those design requirements. When a couplet is not connected to a single street FB or interchange such as shown in FIGS. 9 and 10 the separate couplet streets can be timed separately for conditions particular to its own operation. For example signals can be set to act in a progression, in both streets independently of each other so the traffic can move along not encountering red lights. In this condition a much shorter spacing of arterials can be made; a quarter mile spacing for example. However, the shorter spacing of arterial crossings can affect the capacity of the roadway by being less when shorter lengths of flowing traffic is made.

When the couplet FB is connected to an up coming single street FB or a couplet interchange then the couplet FB needs to have the lane traffic signals, and the right lengths of flowing pack of vehicles in order to work compatibly with those other more requirement demanding elements of the FB system. In this regard the demand for traffic crossing the FB couplet must be taken into account with the type of intersection spacing that maintains the high capacity and level of service that is compatible within the FB system and if there are travel demands for crossing at spacing that does not work well the option is to grade separate that crossing so the flow of vehicular traffic is not made incompatible.

FIG. 8: Couplet FB Intersection with Crossing Arterial

The intersection shown in FIG. 8 is a standard kind of at grade intersection that serves the intersecting of a one-way street and a two-way street. Note that in viewing the image it represents the upper (b) intersection on the page as seen in FIG. 7. To visualize the lower (b) intersection on the page in FIG. 7 this image in FIG. 8 would need to be inverted (turned upside down) so that the traffic flow on the couplet FB would be flowing to the right.

What becomes different from a standard intersection is how signaling is used when the intersection is a part of a couplet FB. As mentioned in FIG. 7, the two (b) intersections could be signaled independently of each other regarding progressive flows of traffic. In contrast to that when the couplet FB is connected to an up coming (as in regards to the direction of flowing traffic) single street FB or interchange involving a couplet the signaling at the intersection requires coordination and the flowing traffic will need “A” pack and “B” gap formation requiring lane traffic signals.

FIG. 9: Couplet FB Interchange with a Single Street FB

This interchange is essentially a “T” intersection with the single street FB (a) coming in from the right side of the image into the couplet FB (b) running north-south on the image. The interchange traffic movements are organized with packs and gaps in order to allow continuous flow of traffic to flow from one FB to another. In an interchange such as this the real life travel demands for cross traffic and turning movements must be employed in the design of the number of lane(s) serving each movement. In a “T” intersection of FB's there is typically a strong need to design for turning movements and to regulate the signals at the intersections to assure that there is an adequate period of traffic flowing time for each movement as well as the number of lanes to do so. If the number of lanes and periods of flowing traffic is accounted for at each traffic intersection a traveler may flow through the interchange and make the necessary turning movements to meet demand without stopping. The single street FB can flow to the north or south without stopping and either the north or the south directed traffic in the couplet FB can flow to the single street FB without stopping. This is a product of the distances of separation involved of the intersections, the speed of the traffic flow and the timing of the packs and gaps.

Of further interest is that the westerly flowing single street traffic can circulate through the interchange and return direction going back through the On Module intersection (d) to go back east on the single street FB. This can occur using the 2 minute signal cycle that has been used as the same timing example that has been used for the single street FB corridor as well. And north bound couplet traffic can turn and move through the interchange and return on the couplet FB going south. And traffic in the south bound couplet FB can make the turns going through the interchange and return on the couplet going north without stopping except for the one left turn (h) shown at intersection (d). This can however be overcome if an access road at element (k), seen as a dashed line on the image, is provided in which case the return direction movement can be made without stopping. To monitor the speed of the traffic flows, lane traffic signals (see FIG. 5) are needed to give the correct prompting of the flows; (the lane traffic signals are not shown in the Figure).

To mention the other movements in the Figure, the (c) couplet is not to be a flowing couplet FB because it is not timed to enter the interchange as required to do so because the length of “A” pack and the closeness of the two streets in (c) couplet will not permit that. The traffic from element (e) must be signaled to wait for the “B” gap in order to do so. That means element (e) does not go into an On Module intersection but simply has a traffic signal to allow traffic to enter the interchange during a gap period of the flowing traffic through the interchange. The element of roadway labeled (f) does provide an “A” pack which has come from either the single street FB or from the southerly flow of the (b) couplet the timing, speed and spacing which allows the traffic flow to return and go through the On Module intersection at (d) and to proceed east. The (g) left turns occur during the particular “A” pack flows through each intersection. The (h) turns are not timed with the “A” packs flows and require a queue lane, a signal and a merging lane to provide safety enter the traffic flow. The (h) left turn at the On Module intersection (d) also does not flow and would require a signal and queue lanes to wait for the turn through the intersection during the “B” gap period of the westerly flow of the single street FB. As mentioned above this left turn movement can be eliminated by the optional (k) access road connection. The (j) right turning movement is a flowing turn during the “A” pack period at the intersection.

FIG. 10: Interchange for two Couplet FB's (Phase X)

First of all there are two couplet FB's, called out as such, a ½ mile apart in which the flowing traffic of “A” packs and “B” gaps are flowing in A, B, A, B, etcetera formation through both of the couplet FB's at the given speed of 30 mph in this example. These two couplets crossing form an interchange between the two FB's where traffic can flow from one FB to the next FB without stopping.

FIGS. 10 and 11 are related in that they are both images of the same interchange but exhibit the two phases of traffic flow as brought about by the “A” packs and “B” gaps that flow through the intersections at each corner of the interchange. In FIG. 8 is shown long black arrows representing “A” pack (a) flows about midway through all four of the interchange intersections with the left turning movements that can occur at that time as well. In the image perpendicular to the long “A” pack arrows are the “B” gaps (b) that the “A” packs are going through. It should also be recognized that not only can traffic take a left turn onto the couplet FB that has been approached but a reversal of direction can be made by making a left turn at the intersection where there is left flowing traffic and then by taking another left turn at the next intersection which will have brought about the reversal of direction onto the original couplet FB that travel was being made on before entering the interchange.

Of course travel can proceed through the interchange without making turns and without stopping at an intersection because of the formation of “A” packs and the “B” gaps that follow them allowing the crossing “A” pack to cross through the intersection during the presence of the “B” gap in the street that is being crossed. It should be recognized that this phasing of the two intersecting couplet FB's must be made for the interchange to work. That means that the interchange “A” packs and “B” gap periods are all equal in time, and therefore length, for all four intersections of the interchange. The equaling of the different travel capacities of the two different couplets through each intersection can be made by making a widening of the lanes at the approach with a 50% increase in the number of lanes so that now there would be for example equal “A” packs and “B” gaps for the two directions of traffic involved at each intersection. The reference of 50% is made in regards to the timing of packs (72 seconds) and gaps (48 seconds) the periods of time that has been used in prior examples as in FIG. 2. In other words the flowing traffic from the couplets must be coordinated with regards to their travel demands (number of flowing lanes) and turning movement volumes so that each couplet works in a balanced manner in the timing of the signals of the interchange. Following the example timing further, that means that each intersection has a 2 minute cycle devoting 60 seconds to both green and red light signals and that each intersection is an On Module intersection.

For a given two lane street of the couplet FB adding another lane makes the additional space for the “A” pack travel volume to get through. This is all true for FIG. 11 as well in that both these FIGS. 10 and 11 are of the same interchange and the information read in the one Figure applies to the other.

FIG. 11: Interchange for two Couplet FB's (Phase Y)

Tin this image the “A” packs and the following “B” gaps have proceeded 60 seconds in time so that the image shows the same interchange that was described in FIG. 10 but where the “A” packs had been, that area of roadway is now occupied by “B” gaps. As a matter of understanding this interchange of the two couplet FB's both of these FIGS. 10 and 11 must be read together because they are one and the same. This occurs in all four corners of the interchange and now FIG. 11 presents no opportunity for an “A” pack to turn unless it has just newly started to enter the first of its intersections upon approaching the interchange. It is because the prior “A” packs have no right turns available in that those turns would be against the flow of traffic. However there are now at the second, third and forth intersections, opportunities to make left turns.

Another way of saying this is in the outcomes of the directions that will result upon which intersection a turn will be made. Upon having reached the first intersection of the interchange in an “A” pack a right turn can be made which means a right turn onto the intersecting couplet FB has been made. In the second intersection the only turn available is a left turn which will give the motorist a left turn onto the intersected couplet FB having gone through the intersection by going straight through the third intersection. If in the third intersection a left turn is made this maneuver has now given the motorist a reversal of direction that was originally been given as when the motorist had approached the interchange. When in the fourth intersection if the choice is made to proceed straight that reversal of direction will have been made in the interchange and now the motorist is proceeding in the opposite direction as originally going. If however a left turn is made at the fourth intersection and the motorist goes through the next intersection, the motorist will have made a right turn from the original direction upon which the motorist had approached the interchange. If the motorist takes a left turn instead of going straight, the motorist will be presented with the same set of left turn opportunities until the motorist decides which way he or she wants to go. These same steps are available from any of the four directions being made upon the two intersecting couplet FB's.

FIG. 12: Application of a Two Couplet Interchange

The application of a half mile square interchange is only likely in a large scale medium density like sprawl of population and development. The interchange itself is shown and explained in FIGS. 10 and 11. The two intersecting Couplet FB's are shown in such a way as to explain that Couplet FB Corridors (b) are more efficient and useful when they are separated by 1, 2, or 3 city blocks (about 118^{th} of a mile). To reflect the fact that the couplets are more efficient when less than the half square mile interchange dimension, the couplets (b) have been configured to be close but then widen at the interchange (a).

The interchange could contain any number of land uses. There could be a town center, a factory, a resident/community any number of uses or reuses. This could be largely a product of an original layout of arterials (c) on a one mile grid. The turning movement (d) expresses the turning (a) as seen on FIG. 11. The letter (e) indicates an intersection of an arterial (or such a roadway) with one of the one-way streets of the couplet FB.

FIG. 13: Couplet Interchange with Grade Separation and Widened On Module Intersections

This is a practical interchange in that various widths of separation of Couplet FB's are represented while also being spaced in quite efficient and functional separations. The couplets (a) are represented in two different widths and are called out as such. Also indicated is the idea that different speeds of travel may occur on the couplets than usually presented in the examples previous to this and different from each other in this interchange of couplet FB's. This is to present the ideas that this is a way to make adaptations to different corridors, roadway spacing as well as their desired speeds of travel. By the introduction of these different intersection designs they may provide the adaptation to make the corridor a viable candidate for higher capacity and higher level of service improvement. A further discussion of this will occur in the Detailed Description of the Invention.

The (b) labeling indicates that a grade separation structure has been applied to that intersection. And the (c) and (d) labels indicate there are different requirements for the corners regarding no turning lanes for the (c) corner and turning lanes for the (d) corners. The (e) label indicates that a widening in the number of lanes has been applied to this intersection as a method for the purpose of balancing the throughput of the respective one-way streets of the respective Couplet FB's to match “A” pack volumes of vehicles. Potentially this could be in a 50% to 50% split of the intersection signal cycle. This is a potential needed design; however the design of intersections require that they respond to the accommodation of the travel demand in that particular intersection and the share of the signal cycle could favor one or the other direction of travel. The corners in this adapted intersection are different in the turning requirement in that (f) does not require a turning lane and the (g) corner does require a turning lane to accommodate turning from one couplet to another.

The different Intersection adaptations are also responding to the fact that the couplets are both narrowly spaced and do not allow for long “A” packs and “B” gaps without the grade separations. The grade separations remove the shortened “A” pack and “B” gap problem and lets the four preceding at grade intersections be the distance to which the speed and number of lanes must be designed for to accommodate the travel demand for the FB corridors.

FIG. 14: “A” pack and “B” gap Phasing for FIG. 13

The diagrams X and Y of FIG. 14 shows the different positions of the “A” packs and the “B” gaps after being allowed to flow for 45 seconds. They essentially change places in the interchange of FIG. 13. The interchange has two On Module intersections and two grade separations that avoid the interruptions to flowing traffic that at grade intersections would have made. The separating distance between the two On Module intersections has a 90 second elapsed time at 30 mph. With the “A” packs and “B” gaps having been made equal in duration prior to entering the interchange (by adjustments to the flow of vehicles such as adding a lane), this allows “A” packs to go through “B” gaps at the On Module intersections without stopping their traffic flow. For further discussion, see the section on FIG. 14 in the Detailed Description of the Invention.

FIG. 15: Couplet Corridor with Couplet Interchanges

The 5 mile Couplet Corridor (a) could be a segment with other FB segments attached or even part of a grid of other Couplets. Also, instead of having a long couplet FB crossing the 5 mile long corridor as shown it could be just a short non-flowing traffic arterial couplet.

Again the reference of the Figure is a large scale layout of medium density development that may or may not be structured on a one mile module of arterials or other roadways. And the (c) potential arterials are at such an interval that the timing of signals at intersections (d) work with the control of “A” packs and “B” gaps so that a Flow Boulevard is made operational. The Intersections (b) are used here to illustrate that a narrowly spaced Couplet FB may need to have a Couplet FB Interchange as shown in FIG. 13 for the corridor or grid, in which it was tied into, to work. However if the crossing couplet to the Couplet FB is merely an arterial couplet with low crossing travel demand the subject (b) intersection could be like an expanded single On Module intersection arterial crossing as similar with FIG. 4 but separated into two closely spaced one-way street intersections that act as one intersection.

### DETAILED DESCRIPTION OF THE INVENTION

What defines and characterizes a Flow Boulevard is that it is an urban interrupted flow roadway facility that can optimize the vehicular flow and minimized the interruptions of crossing traffic to allow vehicles to flow without stopping along its corridors unless the motorist chooses to do so. A Flow Boulevard (FB) roadway system not only allows vehicles to flow continuously through corridors but also allows FB corridors to be strung together end to end and to over time to be able to make a Flow Boulevard network or networks through FB interchanges.

To distinguish the Flow Boulevard system from the average urban context is that of comparing a highly organized system of vehicular movement with one that is essentially much less organized. Most urban areas have evolved from simple beginnings and have retained aspects of earlier low density and low technology features that interrupt the flow of vehicles. That is the main difference in that the FB system removes the interruptions and applies the technology of coordinated movements with timing, spacing and design controls that removes the interruptions of vehicular flow.

Another distinction to be made is that regarding modes of transportation. The FB system essentially takes a legacy roadway and vehicular system of cars, buses and trucks in a medium density urban or suburban context and makes improvements to it so there can be higher capacity and levels of service. The pattern of roadways would be more in the form of a large network or grid. In contrast rail transportation in the urban context is usually a radial plan primarily used for the movement of commuters to a centralized high density destination. The service in the outlying areas becomes sparse as the radial pattern has less interface with the areas the further from the center it goes. And in the medium density primarily vehicular oriented areas rail presents an environmental and functional incompatibility. Rail is a specialty mode of transportation to serve a core city type of function. In most medium density areas the FB system with its bus rapid transit (BRT) capability of flowing busses can, by not being interrupted by traffic signals, match the capacities of light rail without the extremely high cost and disruption. Further the FB and BRT combination can perform a better level of service by including the BRT, local and shuttle services with greater frequency and flexibility without transfers along the corridor and by having multiple bus routes intersecting FB corridors as well. Rail transportation has a very different function in the urban setting.

The primary use of Flow Boulevards at first would probably be to enable and give transportation improvement to existing urban roadways in the medium density context so that they may overcome traffic congestion. The Flow Boulevard system has two basic roadway configurations; 1/ a single street Flow Boulevard having two way traffic and 2/ a couplet Flow Boulevard that is comprised of a pair of one-way streets (a couplet) that provides for traffic in two directions. The one-way streets are separated by a city block or more.

Through these two corridor configurations and the various ways they can be connected, the continuous flow of vehicles along them and from one to the next are also designed to attain an optimum of high capacity and level of service. Beyond the two basic Flow Boulevard configurations there are specific elements of design and engineering that are made to assure those high levels of performance are attained. The elements of design and engineering include, a/ the formation of packs of flowing vehicles (“A” packs) and the formation of gaps between them (“B” gaps), b/ lane traffic signals arranged along a FB corridor to prompt the formation of the packs of vehicles, the gaps between them and their flow through the corridor, c/ “On Module” intersections that conform to engineered and designed conditions that provide appropriate spacing of intersections and the timed flow of vehicular packs and gap between them, d/ occasional grade separations of roadways to maintain the flow of packs of vehicles through the corridors and some portions of interchanges among them, e/ controlled left and right hand turning movements to avoid the interruptions of vehicular flowing packs and f/ designs for interchanges that connect Flow Boulevard corridors and from which networks can be made. Other design elements of the Flow Boulevard system will be called out in the further description of the invention below regarding such features as the timing, vehicular speed and the advancing of specific streams of flowing vehicles and distances to make intersections and interchanges work.

Of the two configurations the single street Flow Boulevard will need the use of the above stated elements for operation more than will the couplet Flow Boulevard. This is primarily because the couplet Flow Boulevard does not have opposing traffic in each of its related one-way streets. Not having opposing traffic simplifies left turns onto side streets, or intersecting arterials and can simplify the timing of signals to provide a progression or adjustments of green light signals and or, to simplify On Module intersection operation. To explain in greater detail the operations of the single street FB would be the appropriate subject to continue with.

Single Street Flow Boulevard

The optimization of throughput on the single street FB and of accommodating cross traffic in the urban context requires that a distance between crossing intersections be made where the most vehicles can flow in both directions on the FB and to also accommodate the cross traffic travel demand which is generated from the adjacent land use to cross the FB corridor. Typically a FB can find application in a medium density urban development of between 3,000 and even 12,000 people per square mile. As an example of what would appear to satisfy these requirements would be a suburban context at the low density range and an existing urban developed area at the upper population range. Intersections in both these population ranges can be found where arterials at a distance for cross traffic on approximately a distance of one mile often have been laid out. Further the time of 2 minutes and 30 mph as the speed to be maintained between intersections will become in the examples being described as the standard time and signal cycle for most of the FB corridors.

The intersections at the one mile arterial spacing that often relates to arterial layouts for medium density urban land use in these examples will be said to be “On Module”. Of course, when designing for a specific location the specific layout of arterials must have the determining context for choosing a standard for the corridor. By having both the single street FB and the couplet FB as a part of the system the chances are that a corridor can be identified for that developed area. But these corridors are sometimes design and engineering challenges. The intension is to make the design without elements of grade separations because of the extra expense involved and of potential visual or other impacts. However with a grade separation applied in a few places in a long corridor the overall low cost of transportation improvement and that the Flow Boulevard has inherently so little impact those grade separations can be warranted. An instance of the use of a grade separated intersection in a corridor for example would be for having a needed intersection with the corridor that was not On Module. The grade separation allows for the continued flow of traffic on the FB without any interrupting disturbance to the packs of vehicles and the formed gaps between them. The needed intersection then has a regular intersection with a standard traffic signal set-up most likely below the grade separated overpass of the FB lanes above it. Off lanes and on lanes for both of the directions of the FB become a part of the standard intersection below. A “diamond intersection” as it is called, is the typical overpass condition as found in the circumstances with freeways passing over arterials where there are intersections with signals below that overpass.

In FIG. 1 is shown the single street FB corridor (a) and crossing arterials (b). It is acknowledged that the layout of existing arterials may vary slightly in distances from one to another. These variations can be adjusted for by varying speeds and signal timing. In conditions with greater variation additional lanes may even be used to adjust for timing and for maintaining street area to provide space for the vehicular packs.

The given desirable speed for the example corridor is to be 30 mph giving a 2 minute travel period between intersections spaced 1 mile apart. This is shown in FIG. 1 as an example of the chosen standard for the corridor. A variation is also shown to exhibit adaptability to shorter distances between On Module existing cross traffic intersections with the adjustment being a slower travel speed for both directions of travel in that shorter segment as the way to keep flowing packs of vehicles to maintain the required 2 minute arrival of vehicles at the two intersections at either end of this shorter segment of FB. A similar adjustment can be made when there is a greater distance between On Module intersections by making a higher average travel speed for that greater distance to be covered to still maintain the 2 minute cycle for the cross traffic at the On Module intersections. As you can see the “Module” is one of timing not distance. Distances between intersections and the speeds between them should be kept within a reasonable range of variation to maintain the timing module and not have a herky-jerky travel experience.

Making well formed packs and gaps is the key to the optimization of utility of the Flow Boulevard system in order to obtain the highest capacity and the highest level of service (LOS) as the definition of the word “optimization” implies. With the corridor having received a standard framework of timed signals to form constants for the corridor (within adjustable limits), it is then the objective to optimize the capacity and LOS for the flowing vehicles in the corridor. This step is made by forming “A” packs of flowing vehicles separated by “B” gaps in an A, B, A, B A, B, etcetera, pattern in both directions of travel to make these patterns of vehicular packs and gaps between them flow continuously through the corridor without stopping. The standardized cross traffic intersections at the approximate 1 mile intervals and having the simultaneous cycling of signalization for all of those intersections throughout that corridor are the “On Module” intersections.

The number of lanes is to be matched in number in each direction and when there is more than one lane in each direction the packs and gaps in a particular direction are to run near parallel with each other. To visualize the two signal phases of an On Module intersection signal cycle, first the green signal for “A” packs passing one another in the On Module intersections see Diagram X in FIG. 2 and for the red signal phase where the “B” gaps in the FB flowing traffic to make the opportunity for cross traffic, see Diagram Y in FIG. 2. These two phases occur with the continuous flowing traffic in the A, B, A, B, pattern of flowing vehicles in both directions and the “A” packs of each opposing direction is entering and passing the other in the On Module intersection followed by the “B” gaps in both directions thus allowing the cross traffic to occur through the “B” gaps all within the 2 minute signal cycle and all occurring over and over as the continuous flowing of traffic through the corridor continues throughout the day. These operations give the capability of the single street FB to provide continuously flowing traffic in both directions throughout the day.

Having a closer look at the flowing “A” pack of vehicles it would be found that the vehicles are a bit off-set from one to the other to allow vehicles the opportunity to change lanes. And a given single street Flow Boulevard will have a minimum of at least two of these On Module intersections and a segment of Flow Boulevard between them. Given the congestion that is building in urban areas at this time it is very likely that long stretches of single street Flow Boulevards could be strung together end to end or connected with segments of the “sister” of the single street FB, the “couplet FB”, end to end to respond to the growth in urban vehicular travel demand.

The On Module intersections are not the only elements of FB design that deal with the adjacent land use traffic. Here as well there needs to be design given to adjacent traffic movement, in relation to the FB corridor, to eliminate the interruption of the flowing “A” packs of vehicles on the FB. FIG. 3 shows adjacent side streets related to the FB. The turning movements however are given restrictions so that those right turns off or on to the FB from side streets as in the “T” intersections labeled (b) in FIG. 3 do not interrupt “A” pack flows. The right hand turns in and out, use merge lanes beside the flowing lanes of the FB so as not to obstruct and interrupt. The median provides organization to the single street FB in eliminating cross traffic from the (b) side streets but also provides the opportunities for left turns onto and off of the FB. In side street (c) in FIG. 3 it is possible to take a left turn to enter the FB, upon a green signal, to cross through the “B” gap in the near side portion of the FB to enter a receiving queue lane in the median so as to not interrupt flowing “A” pack traffic on the far side of the FB and then to wait for a green signal in the queue before safely entering the FB flow of traffic. In a similar manner but basically reversed in sequence a motorist may exit the FB with a left turn as shown in movement labeled (d) of FIG. 3. Many such right and left turns can be designed to take place between the On Module intersections to respond to the travel demand to use the FB and visa versa.

Whereas the On Module intersection holds a prominent role in the operation of the single street FB it is in itself a standard kind of intersection that is found in the typical intersections of arterials at grade. What gives it the prominent role is its location in the corridor and when traffic arrives at it. In FIG. 4 the elements that comprise the standard kind of intersection at grade are set forth. The signalization for the intersection is the same as would be found in the typical arterial intersection controlling all the crossing and turning movements that are being made. What is different is the form in which traffic on the FB arrives at the intersection and when. The traffic on the FB arrives in flowing “A” packs of vehicles and have been timed and spaced so that they do not need to stop as is the usual case as in the case of stop and go traffic for an arterial. Further the “A” packs are given a greater period of time to flow through the intersection than the “B” gaps that afford time for cross traffic to occur for the arterial crossing the FB. With the basic 2 minute signal cycle for the intersection, the FB flow of traffic would have the greater share of those 120 seconds. In our example it could be 72 seconds for the FB flowing phase and 48 seconds for the cross traffic arterial phase (a 60% to 40% split). The arterial portion of time could be less given the travel demand for cross traffic in the corridor or the number of lanes devoted to cross traffic. The main optimization of traffic flow in the FB direction is that it is continuously flowing not losing time for stopping and acceleration, the packs are closely formed giving optimum spacing and the duration of flow is given the greater period in which to flow.

The mechanism that provides the well formed packs and gaps, and controls the average speed so there is not a loss in capacity by stop and go traffic, is the Lane Traffic Signal system arranged between On Module intersections. This arrangement is depicted in FIG. 5. To provide explanation of the functions the Lane Traffic Signal system provides, much of the description of FIG. 5 as found in the section called Brief Description of the Drawings is repeated here in the following few paragraphs.

Lane traffic signals are the follow through or enforcement of the Flow Boulevard concept of formed packs and gaps that allow the best average given speed and the most optimum capacity to be achieved in that urban interrupted flow facility. Lane signals assure that the formation and spacing will be appropriate for both the packs and gaps in providing the conditions for the high LOS and capacity to be attained.

It should be said that there would likely be a learning phase for both the drivers of the FB and for the adjusting of signal prompting in order to get the most out of the FB facility. Since the FB operation basically doubles the capacity of the given number of lanes in the typical corridor that a FB would be applied to, there would be an adequate period of time of a lower potential capacity period that learning could be carried out before heavier travel might be attained through growth and development of the corridor. The lower potential capacity period would have less of a need to “compact” the “A” packs and there would be less prompting needed by the lane traffic light system to assure the formation of gaps between the packs.

Now, to get to the lane traffic signal operations. The lane signals would still use the basic green, yellow and red format of signals but with refinements in signaling in order to better prompt driving behavior. As a prerequisite to the signaling in the FB corridor there would need to be preparatory signaling and timing to begin pack and gap formations before entering the FB portion of the corridor. By the time packs and gaps are in the FB corridor, as defined by the On Module intersections, the range of needed formation prompting for the FB to operate should be now be able to be performed by the lane traffic signals without a great deal of prompting “in” the FB corridor. With this recognition the lane signals are to compact the “A” pack formations to optimize conditions given the current travel demand; light travel allowing greater spacing between vehicles and heavier travel requiring closer spacing. This refers to the time during a day or through the week or as growth in trips may develop over the years.

In FIG. 5 the “X” position of the lane traffic signals would have the basic purpose of maintaining the given speed of traffic flow for that segment of FB and the amount of compactness given the current travel demand. Green lights prompt the maintaining of the desired speed, blinking green lights are for speeding up the movement to obtain closer spacing. Yellow lights are for reducing speed forming less need for vehicular closeness and blinking yellow lights are for caution and slowing of travel while yellow blinking lights accompanied with a red light is for signaling preparation of a very slow speed or potential stopping and a lone blinking red light is for stopping. The lone signal light in the lane traffic signal system is essentially a fail safe light.

As shown in the diagram there would likely be 2 or more of the X position lane traffic signals for the purpose of forming appropriately formed vehicular packs and of maintaining the appropriate speed of a flowing pack while also separating a pack with a well formed “B” gap so as to end up with the portion clear of vehicles that will allow the arterial traffic movements to be performed at the On Module intersections. This is so there are no interruptions in the flow of “A” packs through the FB corridor.

The “Y” position lane traffic signals are a more intense use of forming packs and the following gaps so that there will be no vehicles out of place when the pack enters the On Module intersection. If there is a straggler that vehicle (or those vehicles) will be directed to nearly stop in order to now be formed as a part of the following “A” pack after the “B” gap. This is so there will be no stopping of vehicles at the On Module intersection which would create a disruption to the flow of the flowing A pack that will follow. Between the Y and Z traffic signal positions the stragglers are required to move very slowly in order to prepare to accelerate when given the blinking green light at the Z position in order to now be at the beginning of the A pack that has caught up from behind. This is all to maintain the well formed A packs and B gaps so the FB works with flowing vehicles without interruptions. Drivers will need to learn to drive the FB or they will probably need to be excluded from it so the benefit is preserved for those who can drive it and not diminish the benefit of the high capacity and LOS from others.

The “Z” position lane traffic signals have an even greater purpose of controlling the packs and gaps of the FB in that this is the last prompting that can be made before the On Module signal. At this Z position there are the same basic prompting as found at the Y position but these promptings have become more acute. In addition there are signals that prompt the appropriate use of the left turn queue lanes. Basically if the left turn queue is full it will display red signals indicating that the approaching vehicles will not be allowed to attempt to turn into the left turn queue pocket. The Z position would also have photo or other enforcement for violations of not responding correctly to the signal prompting in any of the flow lanes or lanes for turning.

If a straggler has made inadequate choices it would be smart for the traveler to simply move to the right to find a merging lane to get off the FB flowing lanes. By the time critical timing and spacing of vehicles are needed to require a FB to be made to provide adequate transportation in a corridor, the restrictions for the parking lanes during peak travel periods would likely only be used to allow for emergency vehicles, maybe some taxis and definitely for long bus pockets with additional deceleration and acceleration room to maneuver in. In off peak traffic periods general parking might take place when there is light traffic and the gaps between packs can be taken advantage of for the needed parking maneuvers.

As a note on the lane traffic signal operations, it would be said that the exact program for signal controls can not be prescribed here because there are many different behavioral situations potentially, varying travel demand conditions and specific FB corridor elements to be accounted for in a specific corridor. Those programs and electronic controls are of a separate discipline outside that of the FB concept. It is reasonable to assume that sufficient controls can be attained to provide the pack and gap formations so that the single street Flow Boulevard can be made to work. Signalization of traffic flow has been a part of urban travel for many decades becoming more sophisticated of late by sensors and electronic systems. The Flow Boulevard is simply an advancement of that digitalization technology of traffic flow.

It would be prudent to design a single street FB with greater capacity than the current travel demand requires so the there is ease in accommodating that travel demand without close formations of vehicular packs that were near their theoretical capacity limits. This is to allow for learning periods to use the facility, to develop the ease of use and to allow for the expected amount of travel demand growth in that corridor. On this point it is important to have land use development policies that keep growth and the generation of trips within the range that the transportation infrastructure can accommodate. The Flow Boulevard is getting up to the limits of capacity that can be attained with motorist driving abilities. Certainly greater person trip capacities can be attained with a greater use of the number of buses that are used to provide mobility through the corridor. But this very important relationship of trip generation and the type, character and capacity of transportation infrastructure that is provided has consequences. That is because it is a determinant as to whether it is acceptable and sustainable or not. Policies and rules would certainly have to accompany the FB use so that the FB capacities are not exceeded and penalties made against those who do not use the facility correctly and safely.

Comments on Capacity in General Terms without all the Variable Factors.

In the example corridor that has been described the flowing vehicle packs can be up to 3100 feet long (72 seconds of movement at 44 feet per second). They are at a speed of 30 mph (44 feet/second) and there are 30 signal cycles of the “A” packs and “B” gaps per hour. With an average of 1.75 seconds for vehicles (77 feet of movement) on center moving in the formed vehicular flow; 77 feet divided into the 3100 foot long flow is 41 vehicles in a vehicular (A+B) flow) times 30 signal cycles gives about 1230 vehicles per hour per lane as a general maximum capacity for this example FB design. The 1.75 second on center pace of the vehicular flow may only be reached when the average motorist has “learned” to drive the FB. It may take years to get to the 100,000 motorists that use the corridor but nun the less that is the theoretical capacity that can be stated here without equivocation.

The average arterial with stop and go driving has an average of about 600 vehicles per hour and in peak periods can get into the near failing region of 5 mph travel where capacities of 200 vehicles per hour occur. Mixing near failing portions of a corridor with heavy peak period travel of 500 vehicles per hour may give an average of 350 vehicles in that corridor for a peak period. So a FB system in that corridor can serve the traffic in that corridor in one hour instead of the three hours that would occur with the average stop and go traffic. That is an example of using a FB corridor to eliminate congestion in the urban context. Spreading that same amount of peak period traffic over one and one half hours would make lots of space between vehicles and less stress to the peak period motorist.

There are many examples of flowing vehicles where the average on center pace of vehicles reaches an average of 1.5 seconds. This would give a capacity of over 1400 vehicles per hour in the example FB corridor. And the discussion has been about the peak periods of travel (AM and PM commuting) which implies that the non-peak periods could have pacing of vehicles at 2, 3 and 4 seconds (176 feet on center and 530 vehicles per lane per hour). By the introduction of BRT in a corridor the actual person trip per hour count goes up. This is a further way to make corridors have a higher capacity and relieve congestion. But in the case of buses it takes an attractive level of performance such as can be attained on an FB with speedy bus service to actually work well and to get commuters out of their cars, for example to use the benefits of rapid bus transit.

To provide discussion on the practical application of Flow Boulevards would be important here. Transportation is integral with commerce, and a standard of living is derived from the benefits of commerce. And further, commerce and the affected standard of living results in the quality of life that is acceptable to a socio-economic urban context or not. Large medium density urban patterns are being made as a product of growing urbanization. Low density sprawl has in many instances made economic, resource and environmental problems. Medium density development, where low density and higher density is mixed to provide multiple housing choices while also receiving distributed employment, services and needed developmental institutions can bring a balanced mix of land uses with relative close proximity. This is a pattern of land use and transportation infrastructure that Flow Boulevards can accommodate.

The growth of higher density development and the greater transportation capacity compliments the lower density adjacent development. In the Flow Boulevard corridors, many of the draw backs that low density single land use development makes can be solved. It is to the application of Flow Boulevards in the medium density setting that makes a great deal of sense as well as function. This can especially be the case in the consolidating of multiple communities or within a sub-region, with growth in higher population and having the need to increase the capacity of transportation facilities at low cost in order to receive that growth. What is also of interest is that the greater proximity of those many diverse land uses that round out a pattern of urban life can be placed within the FB corridors and the result can be that there is a reduction in overall vehicular miles traveled (VMT) in a multiple community setting or sub-regional area of urban development. That reduction in VMT reduces resource waste and also reduces GHG emissions.

Couplet Flow Boulevards

So the application of Flow Boulevards in existing developed urban areas to eliminate congestion can make sense; it is also within the context of the consolidating of suburban areas that development of FB corridors and of making networks can make a great deal of sense. In FIG. 6 is depicted the end to end connection of a single street FB to a couplet FB. This adaptation to differing existing street patterns can find use in both urban and suburban locations. As shown in FIG. 6, an On Module intersection to some degree is probably required as a preparatory means of organizing the “A” packs and “B” gaps before the traffic flow enters the single street FB which requires the greater organization of such traffic flow in order to work. In contrast, the traffic flow coming out of the single street FB into the couplet does not necessarily have to have On Module intersections; especially in the sense that couplets are not timed with opposing traffic flows. This is because the couplet intersections that allow cross traffic are separated and that traffic crossing each street of the couplet can be dealt with separately. However this is not always the case because if the couplet is to connect to another single street FB it is probable if not necessary that coordinated intersections at crossing arterials would need to maintain the requirements of On Module intersections in the interim of travel on the couplet between such segments of single street FB's. That would mean that the higher degree of organization is necessary on that couplet and the couplet would actually have to become a segment of couplet FB. This is also the case that a couplet FB would be required when it is being connected to FB Interchanges as shown in FIGS. 9 through 15. A bit more explanation of the couplet FB would be helpful.

Since the streets of a couplet that becomes a couplet FB do not have opposing traffic in each of its one-way traffic flowing streets, left and right hand turns can be made off the couplet streets to the connecting side streets. No median is used in the couplet streets. What the plan view of the couplet looks like is exhibited in FIG. 7. The connecting side streets between the two couplet streets have left turns into those connecting streets from the couplet streets and from within that internal area between the couplet streets (c) as called out as in FIG. 7. A left turn out of those connecting side streets in the internal area will get the motorist into the couplet direction of traffic flow. To make turning movements safer so that exiting couplet traffic does not cross traffic entering traffic as represented by point (e) in FIG. 7, the one way internal streets with the turning movements represented by point (f) are preferred.

Having two streets comprise the couplet corridor makes a great deal of difference from a single street FB. But before becoming a couplet Flow Boulevard it should be differentiated from simply a basic “street couplet” as the wording in the above paragraph is attempting to do. A basic street couplet can in effect perform at high levels of capacity and levels of service without the formation of “A” packs and “B” gaps and the special timing required at the crossing street intersections with the couplet. It can be more flexible in accommodating crossing streets in that the traffic flows on the couplet need not be so organized and may occur more frequently than would be required as On Module intersections would be. However the optimization of traffic capacity and level of service throughput may not be as high as when the basic couplet becomes a fully developed couplet Flow Boulevard. In the FB context the most defining difference is that a basic couplet cannot be connected to a single street FB or become a part of FB interchange without taking on the high levels of traffic organization that is involved in being part of the FB system. These high levels of organization are being exhibited in the various Figures provided and in this

### DETAILED DESCRIPTION OF THE INVENTION

And it is within the FB system that the high capacity and levels of service can be reached in connecting the single streets with paired streets and in making networks of corridors from the differentiated street pattern found in the existing urban fabric. The congested existing urban context or the potential of growth in lower density areas with greater travel demand to come can use the FB system to its benefit. And the couplet FB is an integral part of the FB system.

In FIG. 7 is shown the Couplet FB with Crossing Arterial and Side Street Connections exhibit. Here it is shown the variety of street connections with the couplet that can be expected in an urban setting and potentially a suburban setting as well. The major difference in this setting from a single street FB is that the city block or blocks between the couplet pair (internal area c) are highly accessible from either direction of traffic flow. Here is where higher density of development would be expected. One way streets and two-way streets can make up the “internal side streets” of the couplet corridor.

In finding couplets in the existing urban context one of the couplet streets is likely to be a commercial land use arterial street where as the street to be paired with it to become part of the couplet could be a residential street. In the case of the mainly commercial street the access is good and would have existing commercial on both sides of the street. In a growth corridor there are likely segments where commercial growth will develop in the “internal” area between the couplet streets and on the other couplet street as well. In other segments higher density residential would develop on both streets and the blocks between them. Not only higher density would be expected to characterize the corridor but multiple land uses, institutional, medical and so on.

As the couplet may not need to be a couplet FB at first it would be wise to plan for such an event to transpire in the future. This means not only to have arranged the external and the internal side streets with the couplet with the requirements as shown on FIG. 7 but that the planning for the growth in the corridor should be more than just mindful of that possibility and to be requiring any dedications of land that may be necessary to make the required accommodations for the couplet FB in the future. It is with the required On Module intersection, the forming of the “A” packs and the “B” gaps and the prompting of the land traffic signals that the simple couplet becomes the couplet Flow Boulevard that participates with other corridors in the FB system.

The point of planning ahead to develop the FB corridors is very important because the corridors most likely evolve over time. They would not occur at one time because once the benefits of the FB system are known there would probably be many medium density areas that would want those corridors. This is especially in suburban areas where growth is desired and budgeting of public expenditure is difficult. The great feature of the FB system is that it is basically evolved from the existing street right of ways and by the use of incremental improvement over time. The final expenditure to make a basic couplet into a couplet FB may be a small step, of maybe just adding some lane traffic signals and some required timing. That would be because of having made incremental changes over the growth period of the corridor. So it is as well with the development of the couplet intersection at an arterial crossing as seen in FIG. 8 and with making an appropriate couplet right of way.

The intersection (b) shown in FIG. 8: Couplet FB Intersection with Crossing Arterial is a standard kind of “at grade” intersection that serves the intersecting of a one-way street and a two-way street arterial. This intersection may have been derived from what originally was a commercial two-way street intersecting the arterial. And where the former two-way street had but two lanes in each direction, now a third flowing lane can be added to make the couplet that will have three flowing lanes in each direction. That is an easy adaptation giving much more high capacity as well because there is ample width in the two-way original street.

The real task here in developing the couplet FB may be in how to find a street wide enough or in some way able to carry as much capacity to match the direction of travel formally carried by the two-way commercial street. Although the residential street now only having one direction of traffic to accommodate that travel, it may not be a big problem in the near term to do so. The point being that the potential matching street may have been a bit narrower residential street serving single family homes, but in the future should be wider for adding a third lane of flowing traffic in the future along with other areas for bus pockets, merging lanes and other desirable features. The method of economically obtaining the widening of the street, or finding a way to match capacity to be a pair with that two way commercial street that has added an extra lane then becomes the critical path.

So the beginning of making the couplet FB may need to be started much earlier by using development growth where higher zoning can be a natural course of improving that residential street and that the community can participate in that process economically over time. There may be ways of including the former single family home owners that could then sell there old homes upon the basis of higher land value with higher zoning in effect or other such way of eliminating impacts.

Once, or nearly so, the appropriate width of right of way has been obtained by additional street width dedication in the process of transforming the land use from single family to multiple family or commercial use then what would have been an expensive process of condemnation and purchasing will have been avoided. It then becomes a low cost improvement process of re-stripping lanes, putting in the appropriate signage and traffic controls to establish the couplet and the operation of the side streets as identified in FIG. 8.

There is also a possible alternative way of evolving the right of way by initially using the narrower residential street as part of a basic couplet having just two flowing lanes in each direction. This is feasible in that if a suitable narrower street can be found and made into a couplet having two flowing lanes in each direction this facility may answer the travel demand in the beginning of the corridor growth period. It is because the basic couplet will usually be able to provide an increase in capacity on a lane per lane basis by progressive traffic signalization over the original commercial two-way street with stop and go driving. So by the end of the majority of the growth and the dedication having been made then the third lanes can be added to each of the couplet streets and even more capacity can be added to the corridor when the basic couplet becomes a couplet FB and is connected with other FB corridors.

The interim step of using the established couplet as a fairly high capacity roadway cannot be quickly overlooked. This step may give adequate vehicular capacity in the beginning of the corridor growth and that acquisition cost and FB development cost may be avoided as well until a greater tax revenue base is attained through land use growth. In the mean time the right of way for a wider couplet street on the residential side is being made as dedications are made as land use growth with higher density is made.

There are many variables in the evolving of a corridor to higher land use as well as that of making the transportation improvement. In regards to this, the need for growth as a result of the natural growing economic activity of an area is where corridor growth begins. The fact that the Flow Boulevard system is so low cost and incremental by emerging from the existing context has great advantages over other forms of transportation improvement; for example rail transit. With the addition of rail transit in a corridor the system is either complete or it is not. It is a one step all or nothing improvement process. This inflexibility as well as its high cost of the hardware not to mention finding a low impact reasonably priced corridor makes rail difficult to place in established corridors.

Innovations in financing and in the construction process in land use development can be made to make the transformation of corridors easier as well. Since the use of FB's in existing corridors is so integral and incremental, the evolution of the corridor can take place over many years with prudent budgeting while being of service by providing mobility at each stage of the incremental growth. The fact of the process being integral with the existing street system and that existing commercial and residential land uses that can remain has so many advantages by not changing transportation modes and technologies. And as mentioned there are so many incremental improvements providing flexibility and higher capacity. However as an example, maybe a suitable couplet in a segment of a corridor can not be found to make a couplet FB. That is why the single street FB can be so valuable by getting that doubling of capacity without finding that extra street.

Connecting FB Corridors and Making Networks.

Cities are meant to last and need processes with which to evolve, renew and to improve. The Flow Boulevard system is a way to help make improvements to come about in the long term transportation and land use improvement process of city building.

What will be discussed in the following text and use of figures is to show how the benefits of the single street FB and the couplet FB can be used in the larger context of helping to structure transportation improvement for many communities put together and potentially Metropolitan sub-regions. Certainly vehicles have been evolving and will continue to do so. In that the Flow Boulevard system provides a way to evolve the roadway corridors and networks in a very low cost and integral manner for transportation improvement, it also includes the renewing of relationships with adjacent land uses as well and providing a structure to receive growth for the building of better communities.

The following connecting of FB corridors and of making FB networks having high capacity and levels of service is made possible because of the features of continuous flowing vehicles using the FB system elements of timing, organizing traffic flows and regulating motorist driving movements within the system. While still relying on motorist driving abilities these FB systems may be an evolutionary step in what may eventually have digital and computer controls to time, organize and control of the movements of continuous flowing vehicles on roadways at some point in the future. The focus of this work is to show how the FB system can contributed to solving the existing transportation problems by building roadways, however they may be fundamental to even serve greater potential transportation use in the future.

It was shown in FIG. 6 how to connect a single street FB and a couplet FB. What now will be shown is how to connect an FB corridor to another FB corridor through an interchange. An interchange can add two different travel directions and also three directions in which vehicles can flow to. In the case of FIG. 9: Couplet FB Interchange with a Single Street FB it is essentially a “T” intersection where a single street FB is entering the interchange with a couplet FB from the east on the figure at intersection 1. This hypothetical interchange actually has a basis of having been engineered according to a real travel demand condition. The couplet FB running north and south would be a major distributing and collecting facility for commuter trips to the surrounding area. The single street FB (a) connecting on the east side has 42% less travel demand than the couplet FB running north-south. The movements vary north, south, east, and west between the AM morning distribution function and the PM function of collecting commuters to return at the end of the work day. Based on this understanding the following explanation is made to demonstrate how signal timing can be affected according to the spacing of these intersections of the interchange and the response to the varying AM and PM travel demands.

Intersection 1 is an On Module intersection where the traffic flows of the single street FB (d) are timed where the “A” packs are to cross through the “B” gaps of the north bound couplet traffic at intersection 1. Such intersections must be designed in order to provide the amount of respective times for signal light directing, number of lanes for cross traffic and for turning movements for each of the respective Flow Boulevards and in regards to the AM and PM travel demands on the intersection. The “T” intersection is a clue that the west flowing traffic of the single street FB will have a good amount of right turns at this first intersection. This will help offset a potential increased number of lanes needed in order to provide for the equal amount of time that is to be devoted to the “A” packs of both the north bound couplet FB and the west bound single street FB that will be going through that intersection. In other words, each “A” pack is losing a period of time, roughly 17% (from 72 seconds to 60 seconds in flow time) but is gaining gap time of roughly 25% (from 48 to 60 seconds) in order to get their “A” packs through the intersection during a 2 minute signal cycle. The north bound (b) couplet FB will have 4 lanes for its greater travel demand compared to the 3 lanes each way for the (a) single street couplet. In this explanation it has been assumed that the single street FB and the couplet FB were sharing the 2 minute timed signal cycle in their traffic flows and that basically all that was being done was making equal time for each “A” packs from the two directions in being accommodated by the adjustments. As was mentioned however this particular intersection has a real life basis and that the travel demands for through and turning movements have received preliminary engineering that justified this interchange design. So there is a basis upon which to so deem that a 50-50 split of the signal cycle for intersection 1 would be justified as is other design elsewhere in the interchange.

Following the westerly flowing “A” pack from the single street FB into intersection 2, the flow there has a very high percentage of left turns due from the (a) couplet FB flows to turn south. An even greater demand occurs from south bound (b) couplet FB and these two demands must be out of phase so the “A” packs are going through “B” gaps. And another need is made for the timing of the signal at intersection 2 because of the need of making a gap in those flows to provide for the crossing of the traffic moving east from street (e) at intersection 3. It is done at intersection 2 in the AM split of time with 50% for the southerly (b) couple FB flow, the 40% for the (a) single street FB flow and 10% for making the gap that will be needed at intersection 3 for the (e) traffic movement going east. The PM split for intersection 2 was determined to be 40% for (b) couplet FB flow, 42% for the (a) single street flow and 18% for the (e) flow. These differences are due to the PM collection function being different than the AM distribution function of travel demand. These same percentages for intersection 2, for both AM and PM signal times for the respective movements, are given to the signaling for intersection 3.

The basic AM lead time for the south bound (b) couplet FB flow is 30 seconds and adding the 30 seconds of travel time for the (a) single street flows to reach intersection 2 makes the correct timing for the (a) couplet flows to take at intersection 2 for their turn south. The “A” packs of the single street FB will be flowing through the “B” gap of the south bound couplet FB flow. The (e) gap is accounted for between the (a) single street flows and the (b) couplet FB flows. Similar signal adjustments are made for the PM flows. Again the number of lanes and the amount of signal time to accommodate for through and turning movements must be accounted for in all of the flows of vehicular traffic. In these stated intersection cases the number of lanes remained the same for AM and PM flows and the adjustment for the travel demands was made by the signal timing of green and red light periods.

Intersection 3 will have been accounted for by the timing set forth at intersection 2 for AM and PM flows that cross of intersection 3 going east. What then becomes the design challenge is to accommodate for the flows from intersection 3 over to intersection 1. Here again the flows have basically been ordered through intersection 2 and through intersection 3 but now need compacting in order to be correctly timed to pass through the north flowing (b) couplet FB “B” gap at intersection 1. This occurs by slowing down the (a) single street FB flows but the (b) couplet FB flow and the flow from (e) maintain an approximate 30 mph speed.

The front part of the (a) single street FB flow in order to stay on the 2 minute signal cycle needs to travel the ⅜ mile in 75 seconds which is an average of 18 mph. That puts the front of this returning flowing set of vehicles ready to re-enter intersection) (the On Module) now going east. The shortening of (a) single street FB “A” pack of flowing vehicles is followed by the (e) movement of vehicles which has to compact with the (a) single street flow and go 1980 feet (⅜ mile) in 45 seconds which calculates to be 30 mph on average. Now it is part of the (a) single street FB “A” pack flow. And the south bound (b) couplet FB flow that had been delayed 30 seconds until the (a) flow had passed through intersection 2 now has to go 3960 feet in 90 seconds to compact its flow into the (a) single street FB flows and (e) flows to go through intersection 1 which calculates out to be 30 mph on average.

An ample amount of lane space and the use of the lane traffic signal prompting would be needed to be designed to make this all flows well. An alternative is to use a grade separated structure for this combined and combining eastward flow through intersection 1 which would give all the flows an unrestricted time in which to pass through intersection 1. The compacting if there were an On Module intersection further east would be done from intersection 1 to that next On Module intersection.

As mentioned in the text of the Drawing Descriptions for FIG. 9 the left turn (h) at intersection 1 needs its own queue lanes in order to wait for the signal to give it a go ahead to pass through the “B” gap of the westerly flowing (a) single street FB traffic. That would be the case unless the access road (k) was not made to alleviate that requirement.

The next interchange is for two Couplets interchanging and it is symmetrical. FIGS. 10 and 11: Interchange for two Couplet FB's Phases X and Y are related in that they are both images of the same interchange but exhibit the two phases of traffic flow as brought about by the “A” packs and “B” gaps that flow through the intersections at each corner of the interchange. In FIG. 10 is shown long black arrows representing “A” pack (a) flows about midway through all four of the interchange intersections with the left turning movements that can occur at that time as well. In the image perpendicular to the long “A” pack arrows are the “B” gaps (b) that the “A” packs are going through.

The spacing between couplets is the same and it is presumed that the travel demand and number of lanes for each are the same. In other words this interchange exists in the midst of an evenly distributed population, development and generated travel demand. If this were not the case the various intersections would have to be designed for the needed number of lanes that were necessary and the signal timing for each intersection would need to be adjusted to respond to the various travel demands for each direction of movement. All four intersections would want to be on the same 2 minute cycle so to relate to the “A” pack and “B” gaps that allow the “A” pack traffic to go through the “B” gaps of the couplet FB street being crossed. This works at all four corners of the ½ mile square where the flowing traffic of “A” packs and “B” gaps are flowing in A, B, A, B, etcetera formation through both of the couplet FB's at the given speed of 30 mph in this example.

The crossing of the two couplets FB's form an interchange between the two FB's where traffic can flow through the intersection, or change to either direction from one FB to the next FB (a right or left turn) or reverse direction, all without stopping. This includes all four directional movements for each of the four approaches to the interchange and the third directional change being a reversal of the original direction flowing into the interchange. This makes a highly accessible area of real estate in its center and along the periphery of the interchange. In that 60 second gaps follow 60 second packs there is ample opportunity for cross streets to occur on the sides of the interchange between the interchange intersections. There could be several such street crossings in that the signals timing their movements are timed to their specific location relative to the approaching gap in the traffic flow and would give a full 60 seconds of gap time upon which to cross or turn.

It should be recognized that this equal phasing of the four intersections of the two intersecting couplet FB's makes an easier design for the interchange to work. That means that the interchange “A” packs and “B” gap periods are all equal in time, and therefore length, fOr all four intersections of the interchange. The equal phasing of the intersections also affects the entire couplet phasing coming into the interchange. If there are truly greatly different travel demands flowing through to and through the interchange there could be a great deal of designing, timing of signals and number of lanes for each movement to respond to that irregular loading of travel demand. It can be done within limits however. Otherwise designing for the maximum condition means that other conditions are simply not very efficient in space and material.

There is a basic equaling of the flows that needs to be accomplished so the “A” packs and the “B” gaps are equal in time. The equaling of the different time and travel capacities for example of two flowing lanes with 72 second “A” packs can be balanced to 60 seconds of “A” capacity by adding a third lane. Then there is the 50%-50% split of the signal time and for the accommodation of capacity that is required for “A” packs and “B” gaps that are necessary for the couplets to exchange travel direction and cross through one another in the interchange.

The couplet interchange would mainly be found in a suburban location with a large grid of arterials that have been laid out for land subdivision using arterials at ½ mile and mile intervals. Next to be discussed is an even larger picture of this essentially suburban scale that looks at couplet function relative to the half mile square interchange and the aspects of higher speeds and capacities that may be used well in the suburbs.

In FIG. 12: Application of a Two Couplet Interchange the couplet interchange (a) is connected to longer and more closely spaced couplets (b). There are still references to the half mile and one mile grids but now the notion is that more closely spaced couplets provide for more densely developed corridors and more easily evolved with that higher land use density. In FIG. 7 above the aspects of evolving the closely spaced couplet was touched upon. Here the additional aspect of speed on the couplet and that increased capacities can be attained are brought forth.

First of all the two couplet interchange is deemed to be a valid configuration in that it could represent a small city center within that interchange area, or major land use that an employer or educational institution might occupy. The narrowing of the couplet corridors coming out of the interchange are either extensions of related land uses or are connections to other such kinds of major land use occupiers or attractions. Granted this discussion is rather theoretical but it is often found that actual settings with travel demand attractions and productions can call for much more in the way of innovative system design with the use of the FB system than by just making theory. In any event the Flow Boulevard two basic kinds of corridors and their connections end to end or through interchanges provide a substantial array of infrastructure improvement configurations that are a very much needed set of elements for use in providing transportation improvement, as well as economic and social development.

Comment on Travel Speed and Adjustments.

Different travel speeds and their related capacity have not been touched upon other that the basic urban example referred to by the 30 mph examples that have been portrayed. A comparison of 30 mph and 40 mph will now be made. To begin with these capacities are theoretical maximums and any FB or interchange should be designed so that the actual travel demand only produces traffic volumes that are well within that theoretical range.

To continue, the 40 mph speed is generally a higher capacity speed with safe distances between vehicles than slower speed and even higher speeds. The likelihood of vehicles passing a point at 1.5 seconds intervals at 40 mph is well within reason to expect with experience of continuous flowing driving with vehicles monitored by prompting lane signals. And for the 30 mph travel speed the interval between vehicles will be 1.75 seconds for the calculations.

First a comparison of straight away capacities (outside of interchanges) will be made for the 30 mph speed where the signal cycle is 2 minutes. In the straight away condition the “A” packs are 72 seconds duration for the 30 mph speed divided by 1.75 intervals equals 41 vehicles per signal cycle. In the 30 mph speed there are 30 signal cycles per hour. And 30 cycles times 41 vehicles per “A” pack gives 1230 vehicles per lane per hour. When the straight away enters the interchange the “A” packs are cut in length so that there is a 50-50 split of “A” pack time with “B” gap time so the interchange works as described in FIGS. 10 and 11. The compensation for the shorter length “A” pack in made by adding a lane in the interchange (and the approach) in order to make the adjustment of needing more lane space while maintaining the speed through the interchange. As an example for two lanes in the straight away for a couplet street FB the number of vehicles entering the interchange would be 2 times 1230 or a total of 2460 vehicles. When the third lane has been added for the reduced amount of “A” pack time it allows 1020 vehicles per cycle. Multiplying 3 lanes times the 1020 gives space for 3060 vehicles. This is ample adjustment “room” so that vehicles can maintain the average speed of 30 mph through the interchange and the interchange works with the required 50-50 split of “A” packs and “B” gaps allowing for “A” packs to cross through or turn into the “B” gaps. This extra “room” also lets slower vehicular travel speeds to be taken in the turning movements in the interchange.

In the 40 mph speed the signal cycle is 1.5 minutes (90 seconds). On the straight away a similar proportion of “A” pack and “B” gap (60% to 40%) that was given to the 30 mph speed gives a 54 second duration “A” pack with a 36 second “B” gap. Dividing the 54 second “A” pack by 1.5 second intervals between vehicles gives 36 vehicles per signal cycle. The 90 second signal cycle divided into 3600 seconds per hour equals 40 signal cycles per hour. Multiplying the 36 vehicles per signal cycle times 40 gives 1440 vehicles per hour per lane, and multiplying that by 2 lanes gives 2880 vehicles approaching the interchange each hour. To accommodate this volume of vehicles with a shortened “A” pack through the interchange we first calculate the number of vehicles in the shortened “A” pack. The 45 second duration of “A” pack in the interchange divided by 1.5 seconds gives 30 vehicles per lane times 40 signal cycles per hour gives 1200 vehicles per lane per hour. By adding the extra lane that becomes 3 times the 1200 equaling a space for 3600 vehicles giving the 2880 vehicles that are entering the interchange the extra adjustment “room” they need.

The hourly comparison of 1200 vehicles per lane for 40 mph versus 1020 vehicles per lane for 30 mph gives an increase of about 20% in capacity to the 40 mph travel speed. And this also gives a 25% reduction in travel time by the 40 mph speed. When compared to stop and go driving in moderate to heavy congestion where capacities can be from 600 vehicles per hour and often to as low as 250 vehicles per hour per lane for peak period congestion, the Flow Boulevard capacities and speeds are much better.

Now a discussion of widened intersections and of making grade separations would be appropriate. In FIG. 13: Couplet Interchange with Grade Separation and Widened On Module Intersections, the case is made for closely spaced couplet FB's to have such intersections. In this figure the couplets (x) and (a) are represented in two different widths or separations and are called out as such. This is to present the ideas that this is a way to make adaptations to different corridors, roadway spacing as well as their desired speeds of travel. By the introduction of these different intersection designs they may provide the adaptation to make a corridor a viable candidate for higher capacity and higher level of service improvement.

The different intersection adaptations are also responding to the fact that the couplets are both narrowly spaced and do not allow for long “A” pack and “B” gap stretches without the grade separations. The grade separations at intersections 1 and 3 allow these intersections to be “excused” from having to take part in the normal timing function that intersections at grade need in order to keep the vehicles flowing. This leaves the two On Module intersections (c) at locations 2 and 4 as the only intersections to be timed out of the four. And other than those On Module intersections that are timed according to their corridors and the required lead times of their approaching traffic required for arriving at the interchange correctly, this leaves only the traffic movements going across the interchange from intersections 2 to 4 and from 4 to 2 as the only timed vehicular flows within the interchange. The turning movements of (e) and (d) in all the intersections flow without stopping and there are no turning movements at (f) in any of the intersections.

So with this analysis it should be understood that the critical movement regarding both timing and capacity within the interchange is the length of the “A” pack and “B” gap circulating in the interchange from intersections 2 to 4 and from 4 to 2. These are essentially left turn movements from south bound couplet FB a to couplet FB X and north bound couplet a to couplet FB X. Given the travel demand in the development area that the FB's are responding to, these “left turn” movements may be small enough to be accommodated with single lane turns at the (e) turns at intersections 1 and 3. The calculation for the length of a 1980 foot long “A” pack plus “B” gap divided by 2 to get just the “A” length, then divided by 77 feet per vehicle times 40 cycles per hour times a “daily factor” of 12 to get daily volumes results with a volume of 6,170 vehicles that can be accommodated per lane at those two left turns at intersections 1 and 3. If the travel demand volumes for the intersection are greater than that add a lane.

The aspect that the left turns just analyzed above being the capacity limiting movement in the design of this interchange states that this interchange has good capacity in that the other movements are so unrestricted. The next area to be looked at regarding capacity would be the On Module intersections. And since those intersections would have been designed as a part of each of those respective FB corridors they should perform as well as those other On Module intersections. In other words there should not be a problem if the corridor has been designed correctly.

The characteristics of the critical left turns within the interchange will be further analyzed in that lead time adjustments to the traffic on the couplet FB's are needed so the interchange works. The two grade separations have removed the need to deal with the length of “A” and “B” problem between both the more narrowly spaced couplet FB's X and a. What takes place now, as seen in Phase X on FIG. 14: “A” pack and “B” gap Phasing for FIG. 13, is that the only critically timed intersection movements of the interchange are the 90 second long “B” and “A” flow that takes a left turn at intersections 1 that is proceeding from intersection 4 through 1 to intersection 2 and the separate 90 second “A” and “B” movement flow that has the left turn at intersection 3 that is proceeding from intersection 2 through 3 to intersection 4. These two left turn movements establish the signal timing for the On Module intersections. These two movements are made clear in their operation in FIG. 14 as they switch pattern in relation to intersections 2 and 4 relative to the 45 second phase change that allows the interchange to work. But for these internal interchange movements to occur correctly the approaching traffic flows from the different directions of flow of the couplets have to be given lead times so the packs and gaps align correctly at intersections 2 and 4. All these considerations are being made to accommodate the traffic on both of these two coupled FB's to be able to make all the through and turning movements in the interchange to be performed by vehicles without stopping.

Continuing with FIG. 14 with the example spacing of the two couplets; adding the ¼ mile and the ⅛^{th} mile makes a “A” plus “B” standard movement of ⅜'s of a mile at 30 mph have a 90 second lapsed time. This becomes the 90 second signal cycle timing for the two On Module intersections. So within the interchange the “A” packs and the “B” gaps individually are each made equal or 45 seconds long in duration one after the other, and together are 90 seconds long. So circulating around within the interchange are two 90 second long lengths of the “A” packs and the “B” gaps.

First to be considered are the timing of the couplet FB a flows relative to the interchange. And since they are 45 seconds out of phase, the diagram as shown in the Phase X has the south bound “A” pack on couplet FB a just reaching intersection 2, while the north bound “A” pack has just left intersection 4, which demonstrates that these two 90 second “A” plus “B” segments are 45 seconds out of phase while being correctly timed for the On Module intersections of 2 and 4.

Following the north bound “A” pack of couplet FB a in diagram Phase X that has some of its vehicles turning left at intersection 1; in another 45 seconds as is shown in diagram Phase Y, the “A” pack is now just reaching intersection 2 where it is about to receive a south bound “B” gap which lets it go westerly through intersection 2. For some this kind of movement is not easy to describe or to understand in written communication. Thankfully the diagrams help make the movements clear. But the written description makes clear the fact that these movements are 45 seconds out of phase. Basically the interchange is working.

Next the couplet FB X must be given a lead time so those “A” packs and “B” gaps arrive correctly to enter the interchange. These conditions to be required are to get the A-B-A-B-etcetera flows of the respective streets of the couplets so that they arrive at the right time for the various intersections to work by having “A” packs going through “B” gaps. This responds to the geometry of the intersection and the different times required because of the different distances there are between the On Module and at grade intersections. All of the couplets streets must be timed relative to each other and they relate to the On Module signals at intersections 2 and 4 which are 45 seconds out of phase on the basic 90 second signal cycle which both of them have.

Regarding the relative traffic flows at 30 mph and starting at the Phase X intersection 2 as a reference; couplet street FB X flowing west leads couplet street “a” south bound by 45 seconds. Looking at Phase X again, couplet street X east bound leads couplet street FB X west bound by 15 seconds. And again in Phase X, couplet street “a” north bound leads couplet street “a” south bound by 15 seconds. So in Phase X with the 90 second signal cycle that each of the On Module intersections have they are out of phase by 45 seconds, meaning that couplet street “a” south bound at intersection 2 has a green light whereas couplet street “a” north bound has a red light (during a “B” gap) so that couplet street “x” east bound can allow an “A” pack to go through a “B” gap at intersection 4.

And finally remember this adjustment that is occurring at the widened On Module intersection. These adjustments are the required conditions to get the timing right so the traffic flows are right for packs to cross gaps. So while the traffic approaching the intersection has been given lead times for the various approaching directions, that traffic must also have the 50-50 split of time for packs and gaps. As stated in the discussion of the Two Couplet interchange of FIGS. 10 and 11, an adjustment must be made to change the typically 60% “A” pack and 40% “B” gap time to a 50% duration for each flow prior to entering the interchange. As stated this can easily be made by an additional lane for the couplet traffic flow before getting to the On Module intersection.

FIG. 15: Couplet Corridor with Couplet Interchanges applies the interchange of FIG. 13 to a corridor condition which in FIG. 15 is 5 miles long. In contrast to the land use setting that was portrayed in FIG. 12 where there was a central major land use within the Two Couplet Interchange this two Couplet Interchange fits in a more urban setting with closely spaced streets.

Here the corridor has a closely spaced couplet FB and would have characteristics like in FIG. 7 regarding side street layout and similar strategies involved in evolving the corridor to higher density or in its renewal. This is said in that this is likely to be a pattern that if used in a suburban setting would be featured as a growth corridor. But this corridor could also be that medium density inner city area that needs renewal or the way to eliminate congestion. The FIG. 13 interchange is compact so in renewal it could lend a “least impact” approach to adding much higher capacity and level of service to take away the dregs of congestion on a community that needs revitalization.

The 5 mile Couplet Corridor a. could be a segment with other FB segments attached or even part of a grid of other Couplets as suggested by the intersecting corridors with (a) in parenthesis. Also, instead of having a long couplet FB crossing the 5 mile long corridor as shown it could be just a short non-flowing traffic arterial couplet.

Again the reference of the Figure is a large scale layout of medium density development that may or may not be structured on a one mile module of arterials or other roadways. And the (c) potential arterials are at such an interval that the timing of signals at intersections (d) can work as On Module intersection such as with FIG. 4 with the control of “A” packs and “B” gaps so that a Flow Boulevard is made operational. The Intersections (b) is used here to illustrate that a narrowly spaced Couplet FB may need to have a Couplet FB Interchange as shown in FIG. 13 for the corridor or grid in which it was tied into, to work.

Brief Summary Comment:

It has been the objective of the Flow Boulevard system to develop enough practical designs for corridors and intersections so that they can be used in urban and suburban settings with the objective of fixing congestion problems, or of providing infrastructure improvement that is supportive to renewal or for growth. The reason there are no single street FB interchanges with other single street FB interchanges is that the closeness of the streets require grade separations for practically all the crossing movements and half of the turning movements. These requirements gets away from the low cost practical approach that has been taken and those intersections do not use the “A” pack and “B” gap principles which optimize the interrupted flow roadway.

### Mode Contemplated of Carrying Out the Invention

The most recent work on the transportation improvement concept has transformed the thinking from being couplet based to now that of the new Flow Boulevard systems concepts that utilize the highly organized flow of traffic. Prior to that breakthrough the thinking was that couplets were enough of an improvement. However, upon discovering how greatly capacity and level of service was attainable by using the new traffic controls in a single street and by also discovering how to make interchanges to connect different FB corridors the result was that now a system had been made and that it was new.

Now the reasoning is to attain a patent of the invention of this FB system so that the ideas can be disclosed to the public and to be watchful that it is used well and to the benefit of improved transportation and land use. And as well the motivation is not only to announce the finding and open it for use but to protect it from not being used. There are competing sentiments in transportation improvement and if one of those entities were to obtain the patent in order not to use the concepts or to obstruct the use of the FB system, that could exclude the use of people that could benefit from using it as well.

Once the use of the system is protected then the thinking is to first disclose the concepts through the preliminary transportation improvement plans that have been made for corridors within the City of Los Angeles, Calif. A website that has been used for years as an open “workshop” for ideas relative to the previous Flow Boulevard conception and could now be used to exhibit the new ideas in proposals for corridor improvement in specific Los Angeles corridors. In addition, the notion is advanced that the 88 municipalities of Los Angeles County should make use of the FB system to better provide for growth and socio-economic development through infrastructure improvement.

The website address is www.flowboulevardplan.com. Cities converse with one another through many channels of communication and in that way the ideas would be open to national access and potential use as well. The invention patent is needed to protect its use and to also bring it to the attention of the public who would be the major beneficiaries of the ideas.

The following specific corridors for which conceptual plans have been made and would be exhibited on the FB website include eleven miles of the Santa Monica Boulevard corridor where both a single street FB and a couplet FB are used end to end. In FIG. 6 is portrayed the principles of connection. On the western end of that Flow Boulevard proposal (not yet put on the website) is a proposed interchange that is essentially expressed by FIG. 9 of the drawings. On the FIG. 9 drawing the Santa Monica single street FB enters the interchange from the east side. The single street FB and a couplet FB comprise the interchange. The couplet FB is proposed to be used as a frontage road to the 1-405 freeway and would extend for approximately 6 miles in the proposal. The couplet FB would be the key transportation improvement facility in a multi-modal transportation improvement to eliminate the congestion in the West Los Angeles area. The capacity of the 1-405 has been greatly exceeded in many ways and has essentially become a freeway bottleneck condition for which over 100,000 person trips per day of additional capacity is needed in the north-south direction to solve for the travel demand, the distribution and collection of commuters to the Westside of LA and to fix the very complex set of congestion problems. While the state transportation agency Caltrans, is adding one lane to the north bound side of the 1-405 freeway it will be insufficient to solve the problems of the Westside communities. Essentially a patent on the Flow Boulevard system is needed in order to protect it so that a public can benefit by its use if the decisions to do so are made.

The local Metropolitan Transportation Authority, along with local political clout, has concentrated on developing commuter rail for the last thirty years. However that system once built will serve less than 2% of the travel in the MTA area. Meanwhile the legacy surface transportation system is deteriorating and is becoming exceedingly congested. Whereas the freeways have facilitated sprawl for decades there will now be few built because of anti-sprawl legislation (SB375) and there is little money for that kind of infrastructure anyway. It is a good time for the FB system to make a contribution by being low cost and able to make improvements that affect the majority of travel where medium and long distance trips currently produce over 80 million miles of travel each day in the MTA area. One of the surprising benefits is that the FB system can structure the consolidation of population growth and in the process dramatically reduce vehicular miles traveled. The average suburban trip is over 15 miles long and by building about 200 miles of FB over the next 20 or 30 years, it can reduce the average trip to half that. A 20% population increase over the 20 years of growth made with the combination of the dispersed development of employment and community services in the new and old development can reduce travel so as to absorb an additional two million more people to LA County without increasing that 80 million miles of travel per day. So instead of the new two million in population growth adding another 17 million trips per day to the 80 million trips, there would be no increase in the trip mileage by being absorbed because of shorter average trip length. For one fifth of the amount the MTA wants to spend on rail the FB system can reduce travel mileage cost and GHG emissions by greater than twenty times as that of the cost rail projects.

There would probably need to have a formal Flow Boulevard institute, corporate entity or planning organization to disseminate the use of the Flow Boulevard concepts and to follow their development. Making instruments of service with American Institute of Architects contracts for services (of which I am a member) and using contractual agreements with planning firms, clients and design-build contractors for production of developments and by successfully getting the MTA to plan for Flow Boulevard development; administration of the work that is to be made can be begun.

I have not thought much about the best mode of carrying out the invention but I'm sure lots of people would have lots of ideas from which good processes and practices could be developed. There are many foundations and public oriented service organizations that could use the FB benefits of infrastructure improvement to further the social and economic development objectives for the public at large. By using their existing organizations, their networking and their political pull a great deal of progress can probably be made.

And finally it would be a privilege and an honor to also post the USPTO published document of a patent for the Flow Boulevard system on the Flow Boulevard website.

### SUMMARY OF THE INVENTION

There are two kinds of Flow Boulevard (FB) configurations that can be used to gain higher capacities and levels of service among the various types of urban interrupted flow facilities. There is the single street Flow Boulevard and the couplet Flow Boulevard. What is new are the elements and relationships within the single street FB that allows it to be designed and engineered to gain the greater utility of higher capacities and sustained higher levels of service for the single street Flow Boulevard urban roadway. Those elements and relationships which make the single street FB to work can also be used to connect it to a couplet FB to make a mixed FB corridor and also to make interchanges between FB corridors in which to make FB networks. Both of these two kinds of Flow Boulevard corridors, their connections to other corridors and to other corridors through interchanges can allow vehicular traffic to flow without stopping through each and on to the next. Flow Boulevards comprise a system that can be designed and engineered to improve existing streets in the urban or suburban setting and for new urban development.

Using normal driving abilities by the public in market purchased vehicles the design of the Flow Boulevard takes away the majority of interruptions made within the corridor itself and by cross traffic that reduce capacity and travel speed that occurs in the usual disorganized urban street layout. The disorganized layout is where too many cross street intersections and turning movements “chop-up” vehicular flow and thereby can lead to congestion during periods of heavy travel demand. Further the unorganized street layouts can make a loss of capacity by the inability to synchronize traffic signals so that traffic can flow in synchronized flow.

The optimization of flowing vehicles within the existing right of way (ROW) on a single street FB is made by forming “packs” of vehicles that can flow without stopping in both directions by having synchronized traffic signals at appropriately spaced intersections for the packs of the opposing directions of flowing vehicles to pass through those intersections at the same time. The intersections will be called “On Module” intersections and they are at grade as is the entire Flow Boulevard system of which is being described generally is.

Between the packs of vehicles is a well formed “gap” between the packs of flowing vehicles. Each pack followed by a gap is to comprise a basic On Module signal cycle to which the On Module traffic signal is timed. The repeated period of time serving the A pack plus the B gap signal cycle substantially repeats at the same time throughout the entire FB corridor which allows the, A-B sequence of flowing traffic which occurs in both directions to pass one another at the “On Module” intersections at the same time; “A” pack to “A” through the intersection and “B” gap to “B” gap as well. The simultaneous passing of the “B” gaps allows cross traffic from the intersecting street and pedestrians to cross the Flow Boulevard without interrupting the flow of the “A” packs of vehicles in both directions on the single street Flow Boulevard. To assure that “A” packs and “B” gaps are formed sufficiently well there is a system of lane traffic signalization to provide the required prompting of slowing, maintaining or quickening of speed to form the “A” packs and of forming the “B” gaps.

The formation of closely spaced vehicles in the packs, the fact that these vehicles do not stop and that the minimization of interruption made by crossing traffic, optimizes capacity and the level of service for moving traffic in the corridor as compared on a lane by lane basis with other interrupted flow urban facilities. The Flow Boulevard is comprised of two or more of these timed On Module intersections and the well spaced segment of roadway between them that controls side street intersections and turning movements on and off the Flow Boulevard. The intension is of course to have as many desired segments placed together to serve and accommodate the travel demand in that corridor to overcome the debilitating of transportation by vehicular congestion. This means the connection of single street FB's with couplet FB's as well as with other FB corridors through FB interchanges.

All of these elements that comprise the Flow Boulevard need to be designed, timed, engineered and have the appropriate capacity to serve and solve for the given context and travel demand in that corridor. What is the likely application of the Flow Boulevard is for it to supply the additional capacity to remove the congestion and to allow traffic to move as needed in the context of an area with existing development. It is a way of fixing the congested street problem that so many large cities have and also medium density suburban areas have as well. And the key to this is that it can generally be done within the existing right of way of existing streets; no street widening.

Since the Flow Boulevard can essentially double the capacity of an existing street, on a lane for lane basis, the build up of deficiency in capacity in an existing corridor should not be more than 100%. In that circumstance the Flow Boulevard can become an integral kind of solution with a very low impact and low expense improvement to fix the congestion problem. If the deficiency build up is greater than 100%, a program of vigorous bus rapid transit use can provide that additional person trip capacity in that corridor.

Furthermore if the congestion may be a fairly localized or “bottleneck” kind of condition it is better to use an FB than to introduce an incompatible mode of transportation such light rail. The FB can address the specific “bottleneck” location with higher capacity. Whereas rail would require transfers or the duplication of the entire length of corridor to simply service that bottleneck area. Light rail would generally be twenty times the expense as a Flow Boulevard fix on a mile for mile basis or even more if there is not a low cost right of way available to be used by a light rail facility. In contrast to expensive and the normal incompatibility light rail service, the Flow Boulevard readily receives and makes buses have truly “rapid” bus transit. And the flexibility of having converging bus lines of the “bottleneck” area makes a much greater level of performance for the transit user.

It would be expected that segments of both kinds of Flow Boulevard would be developed in various parts of a city or county and not at first be connected. However as growth and consolidation of density takes place it would be to their advantage to connect such corridors to form networks. This would likely occur in two different kinds of urban development. The first is a medium density urban area where congestion has already developed and there needs to be a way to eliminate congestion so the commerce and the maintaining of an attractive quality of life can be made. The other area of development would be a lower density urban density that is growing with medium density corridors as a way to improve its livability, efficiency and with proximity to community functions to reduce vehicular miles traveled and reduce GHG emissions.

When combined with strategies to provide higher density land use in corridors in an existing lower density area, there are a number of benefits to be obtained. When part of a consolidating pattern of multi community development and higher density multi-use land development in corridors is made, there would be a tendency to reduce the average trip length and by so doing would reduce vehicular miles traveled in that multi-community area. With bus rapid transit being introduced with FB's this also tends to reduce resource waste and GHG emissions. At the same time the Flow Boulevard corridors become “in-fill” transportation facilities that can take trips off a freeway network thereby reducing travel demand on those facilities and probably extending the service life of the freeway system. These latter transportation outcomes would mainly apply to medium density urban development over large areas as would occur surrounding “core” downtown types of city forms and with multi-centered cities that mainly have a legacy of surface transportation facilities such as freeways and arterials in both large grids and of patterns shaped by other factors like geography.

A Flow Boulevard optimizes traffic flow in an urban two way street interrupted flow roadway facility by providing the organization of traffic to flow through a corridor without stopping. Using normal driving abilities by the public in market purchased vehicles the design of the Flow Boulevard takes away the majority of interruptions made by cross traffic that reduce capacity and travel speed that occurs in the usual disorganized urban arterial pattern where too many cross street intersections and turning movements that “chop-up” vehicular flow creating congestion and loss of capacity.

The optimization of flowing vehicles is made by forming “packs” of vehicles that can flow without stopping in both directions and having synchronized traffic signals at appropriately spaced intersections for the packs of the opposing directions of flowing vehicles to pass through those intersections at the same time. The intersections will be called “On Module” intersections. Between the packs of vehicles are well formed “gaps” which are also timed to occur at the same time at the “On Module” intersections so that cross traffic from the intersecting streets and pedestrians can cross the Flow Boulevard without interrupting the flow of the packs of vehicles on the Flow Boulevard. The formation of closely spaced vehicles in the packs and the fact that these vehicles do not stop optimizes capacity and level of service for moving traffic in the corridor on a comparative lane by lane basis. The Flow Boulevard is comprised of two or more of these timed On Module intersections and the well spaced segment of roadway between them that controls side street intersections and turning movements on and off the Flow Boulevard. The intension is of course to have as many desired segments placed together to serve and accommodate the travel demand in that corridor to overcome the debilitating of transportation by the congestion now occurring or for the expected future congestion and dysfunction that could take place.

All of these elements that comprise the Flow Boulevard need to be designed, timed, engineered and have the appropriate capacity to serve and solve for the given context and travel demand in that corridor. What is the likely application of the Flow Boulevard is for it to supply the additional capacity to remove the congestion and to allow traffic to move as needed in the context of an area with existing development. It is a way of fixing the congested street problem that so many large cities have and also medium density suburban areas have as well. And the key to this is that it can be done within the existing right of way of existing streets. Since the Flow Boulevard can essentially double the capacity of an existing street the built up deficiency of capacity in an existing corridor should not be more than 100%. Therefore the Flow Boulevard becomes an integral kind of solution with a very low impact and low expense improvement to fix the congestion problem. Further more the congestion may be a fairly localized or “bottleneck” kind of condition that does not warrant the addition of another system and its impacts with such a system as rail that duplicates the overall length of origin and destination that would be involved in lowering person trips in that short congested area. Light rail would generally be twenty times the expense as a Flow Boulevard fix on a mile for mile basis or even more if there is not a low cost right of way available to be used by a light rail facility.

The reality is that the single street Flow Boulevard corridor is the more difficult to make and design to make in a corridor as compared to its sister configuration, the one-way couplet Flow Boulevard. The one-way couplet Flow Boulevard will inevitably have a greater amount of right of way to accept the increase of capacity in a corridor in that it is made by two parallel streets simply separated by a city block or more. In addition the turning movements and signal timing is much more simple to accommodate. Between the two configurations of the single street Flow Boulevard and the one-way couplet Flow Boulevard that can be placed end to end, adequate corridors can be made through most medium density urban areas.

The application for patent here is for a single street Flow Boulevard, now to also be referred to as a single street FB. To differentiate the one-way couplet Flow Boulevard it will be designated as a couplet FB. Even though the single street FB is the more difficult to design for regarding timing and for the control of vehicles, the single street FB has the more universal ingredients, namely “packs’ of vehicles and “gaps” between them that become the means to piece the two configurations together end to end and through interchanges between them to make Flow Boulevard networks over large areas of urban development still maintaining flows of vehicles that do not stop.

It would be expected that segments of both kinds of Flow Boulevard would be developed in various parts of a city or county and not at first be connected. However as growth and consolidation of density takes place and areas of the standard arterial pattern develop congestion they would benefit by developing connected Flow Boulevards as a network. When combined with strategies to provide higher density land use in corridors there are a number of benefits to be obtained. When part of a consolidating pattern of multi community development and higher density multi-use land development in corridors is made there would be a tendency to reduce the average trip length and by so doing would reduce vehicular miles traveled in that multi-community area. At the same time the Flow Boulevard corridors become “in-fill” transportation facilities that can take trips off a freeway network thereby reducing travel demand on those facilities and probably extending the service life of the freeway system. These latter transportation outcomes would mainly apply to medium density urban development over large areas as would occur surrounding “core” downtown types of city forms and with multi-centered cities that mainly have a legacy of surface transportation facilities such as freeways, arterials in both large grids and of patterns shaped by other factors like geography.

There are two kinds of Flow Boulevard (FB) corridors that can be used to gain higher capacities and levels of service among the urban interrupted flow facilities. There is the single street Flow Boulevard and the couplet Flow Boulevard. What is new are the elements within the single street FB that allow it to be engineered to gain the greater utility of higher capacities and sustain higher level of service for the single street Flow Boulevard urban roadway. Those elements which make the single street FB to work can also be used to connect them to couplet FB's to make mixed FB corridors and also to make interchanges between FB corridors in which to make networks. Both of these two kinds of Flow Boulevard corridors and their connections can allow vehicular traffic to flow without stopping through each and on to the next. Flow Boulevards can be designed and engineered to improve existing streets in the urban setting or for new urban development.

The two kinds of Flow Boulevards and their connections comprise a Flow Boulevard system that can be applied to the urban context for the elimination of congestion in existing street conditions or to gain high performance of vehicular transportation in new urban development. It is the objective of this application to gain a patent for the Flow Boulevard as a system and for its components that are involved.

1. A Flow Boulevard (FB) allows continuously flowing packs of vehicles, either being on a single street FB or a couplet FB (a FB made from a pair of one-way streets) by having spaced and timed intersections and the use of well formed flowing packs of vehicles and the well formed gaps (where no vehicles are flowing) between them on the Flow Boulevard which lets the well formed flowing packs of vehicles on the Flow Boulevard to flow through the spaced and timed intersections during the green portion of the intersection signal without stopping, and the following well formed gap behind the pack to then receive a red signal which allows the cross traffic at the spaced and timed cross street intersection to receive its green signal to allow cross traffic through the gap where upon the crossing traffic does not interrupt the continuously flowing packs of vehicles on the Flow Boulevard.

2. By the use of the traffic organization of well formed flowing packs of vehicles separated by well formed gaps between them on Flow Boulevards which have spaced and timed intersections for cross traffic, the continuously flowing packs of vehicles on the Flow Boulevard can be designed to go from a single street Flow Boulevards to a couplet Flow Boulevard (and visa versa) end to end or flow continuously through Flow Boulevard interchanges which have spaced and timed intersections that allow the well formed packs of vehicles to flow through the well formed gaps continuously without need to stop in order to flow to other Flow Boulevard corridors, where vehicular packs flow continuously, or to form Flow Boulevard network configurations where vehicular well formed packs also flow continuously.

3. A Flow Boulevard can exchange traffic with side streets by having it enter and exit the flow of a Flow Boulevard by designing turning movements that do not cross over and interrupt the flowing well formed packs of vehicles on the Flow Boulevard and by the timed use of crossing traffic through the well formed gaps between the flowing packs of vehicles on the Flow Boulevard by timed and controlled movements with traffic signals.

4. A Flow Boulevard can use standard at grade, timed and spaced intersections with timed signalization to let the flowing packs of vehicles flow through the intersection without stopping on the green signal and during the well formed gaps that follow the packs to let cross traffic through the gaps between the well formed continuously flowing packs on the Flow Boulevard and also during that gap period to have left and right turns from the Flow Boulevard traffic from merging lanes for right turns and from left turn pockets for left hand turns from the Flow Boulevard.

5. Well formed continuously flowing packs of vehicles which are spaced efficiently can be made by motorists responding to a system of traffic signals that are arranged to prompt the vehicles in each flowing traffic lane of the Flow Boulevard and to also make well formed gaps between the vehicular packs, where there are no vehicles, so that with these organized packs and gaps gain high levels of capacity and levels of service of vehicles traveling through the well timed and spaced signalized intersections of the Flow Boulevard where cross traffic also occurs on the appropriately timed and spaced intersections with traffic signals.

6. A couplet Flow Boulevard can make an interchange with a couplet Flow Boulevard where each Flow Boulevard traffic can flow to the other without stopping by timing and spacing the respective intersections of the interchange according to the speed and sequence of the flowing packs of vehicles and the gaps between them so as to allow the flowing packs of vehicles to go through respective gaps at the intersections of the interchange so that vehicular packs flow through the interchange without stopping to the other Flow Boulevard or the go through the interchange without changing to the other Flow Boulevard and continue in the same direction as originally traveled or to reverse direction on the Flow Boulevard that the traveler has approached the interchange all without stopping.

7. A single street Flow Boulevard can make an interchange with a couplet Flow Boulevard where each Flow Boulevard traffic can flow to the other without stopping by the timing and spacing of the respective intersections of the interchange according to the speed and the sequence of the flowing packs of vehicles and the gaps behind them so as to allow the flowing packs of vehicles to go through respective gaps at the intersections so that vehicular packs flow through the interchange without stopping and can flow to the other Flow Boulevard or to go straight through the interchange or reverse direction of flow of the original direction the motorist was taking on the respective approach to the interchange on a Flow Boulevard by circulating through the interchange, all without stopping.
